(19) United States
(12) Patent Application Publication
(10) Pub. No.: US 2026/0095541 A1
(43) Pub. Date: Apr. 2, 2026

(54) COLOR VERIFICATION SYSTEM, METHOD OF CONTROLLING COLOR VERIFICATION SYSTEM, COLOR VERIFICATION SERVER, AND STORAGE MEDIUM

(71) Applicant: CANON KABUSHIKI KAISHA, Tokyo (JP)

(72) Inventor: HIDEMI SASAKI, Kanagawa (JP)

(21) Appl. No.: 19/337,715

(22) Filed: Sep. 23, 2025

(30) Foreign Application Priority Data
Oct. 2, 2024 (JP) 2024-173167

(51) Int. Cl. H04N 1/60

(52) U.S. Cl. CPC H04N 1/6033

(57) ABSTRACT

A color verification system for managing a color verification task includes: at least one memory and at least one processor which function as: a management unit configured to manage the color verification task by dividing the task into two or more phases including a first phase and a second phase; a linking unit configured to link the first phase to a first work time and the second phase to a second work time; and a notification unit configured to notify a user that work of the first phase is incomplete, in a case where a work completion event for the first phase is not detected and the first work time has elapsed.

### BACKGROUND

### Field of the Technology

The present disclosure relates to a color verification system, a method of controlling the color verification system, a color verification server, and a storage medium.

### Description of the Related Art

In the commercial printing field targeted at posters, pamphlets, and the like, it is important to be able to reproduce the colors in print data with high reproducibility on a print medium (hereinafter referred to as “color reproducibility”). A color verification system for verifying and managing the color reproducibility of a printer device has long been widely known, and is also called a color management system.

Adding a schedule management function to the color verification system makes it possible to support periodic execution of color verification by an operator. A schedule management system of the related art, including but not limited to the color verification system, has incorporated various technologies to efficiently execute a work schedule (hereafter referred to as a “task”). For example, Japanese Patent Laid-open No. 2020-052802 (hereafter referred to as a “Document 1”) discloses a technology to notify a notification destination of a message in a case where a work management apparatus determines that there is a work delay in a task.

Only in a case where a predetermined time such as a finish time has arrived or upon request from an administrator, the work management apparatus according to Document 1 executes processing for determining whether there is a work delay and notifies a notification destination of a message.

There is a demand for a technology to notify a work delay in a timely manner.

### SUMMARY

A color verification system according to the present disclosure is a color verification system for managing a color verification task, includes: at least one or more processors and/or circuitry which function as: a management unit configured to manage the color verification task by dividing the task into two or more phases including a first phase and a second phase; a linking unit configured to link the first phase to a first work time and the second phase to a second work time; and a notification unit configured to notify a user that work of the first phase is incomplete, in a case where a work completion event for the first phase is not detected and the first work time has elapsed.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of a color verification system.

FIG. 2 is a software configuration diagram of the color verification system.

FIG. 3 is a conceptual diagram of a color verification chart print preparation time and a color verification execution work time.

FIG. 4 is a diagram illustrating a notification destination setting screen for various setting applications.

FIG. 5 is a flowchart in a case of displaying the notification destination setting screen for various setting applications.

FIG. 6 is a flowchart in a case of saving the notification destination setting screen for various setting applications.

FIG. 7 is a flowchart of a main loop of a Web Server.

FIG. 8 is a diagram illustrating a data structure of a notification destination setting list.

FIG. 9 is a diagram illustrating a screen of a color verification setting application 291.

FIG. 10 is a flowchart in a case of displaying the screen of the color verification setting application 291.

FIG. 11 is a flowchart related to color verification setting processing.

FIG. 12 is a diagram illustrating a data structure of a color verification setting list.

FIG. 13 is a state transition diagram of a color verification task.

FIG. 14 is a flowchart in a case of saving the settings of the color verification setting application 291.

FIG. 15 is a flowchart of a main loop of a scheduler engine.

FIG. 16 is a flowchart of color verification preparation start timer signal processing.

FIG. 17 is a flowchart of color verification preparation delay detection timer signal processing.

FIG. 18 is a diagram illustrating a setting screen of a colorimetry application 292.

FIG. 19A is a diagram illustrating a colorimetry screen of the colorimetry application 292.

FIG. 19B is a diagram illustrating a colorimetry screen of the colorimetry application 292.

FIG. 20 is a flowchart upon start of color measurement through the colorimetry screen of the colorimetry application.

FIG. 21 is a flowchart upon start of color measurement through the colorimetry screen of the colorimetry application.

FIG. 22 is a flowchart upon completion of color measurement through the colorimetry screen of the colorimetry application.

FIG. 23A is a diagram illustrating a display example of various warnings on a device-side UI.

FIG. 23B is a diagram illustrating a display example of various warnings using a warning light.

FIG. 24A is a diagram illustrating a superimposed display example of various warnings on a color verification setting application screen.

FIG. 24B is a diagram illustrating a display example of a schedule mode.

FIG. 25A is a diagram illustrating an example of displaying a phase state on an application switching button.

FIG. 25B is a diagram illustrating a display example of a color verification setting button.

FIG. 25C is a diagram illustrating a display example of the color verification setting button.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with “S”.

### First Embodiment

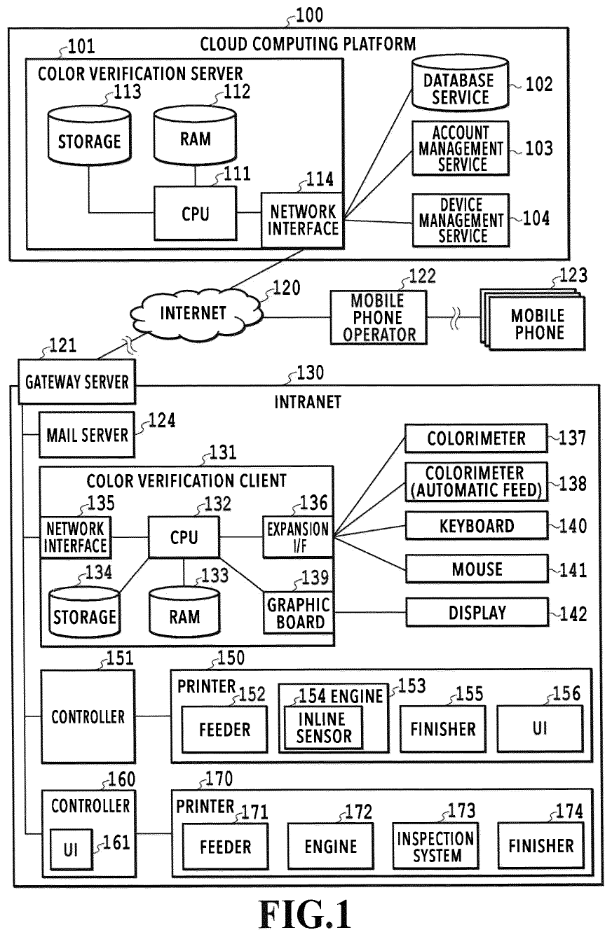

FIG. 1 is a hardware configuration diagram of a color verification system. The color verification system includes a color verification server 101, a Database service 102, an account management service 103, and a device management service 104, all of which operate on a cloud computing platform 100.

The color verification server 101 is a virtual computer (virtual PC), including a CPU 111, a RAM 112, a Storage 113, and a Network Interface 114. The CPU 111 is a central processing unit for executing a program deployed on the RAM 112. The RAM 112 is a storage area for temporarily storing a program to be executed by the CPU 111 and data used by the program. The Storage 113 is a storage area for storing a program to be executed by the CPU 111 and data used by the program. The Storage 113 may be a hard disk drive (HDD), a solid state drive (SSD) or the like. The Network Interface 114 is an interface for communicating with an external service of the color verification server 101, a client PC, and the like. For example, the color verification server 101 may have a plurality of network interfaces for connecting to a cloud computing platform, the Internet, and the like.

The hardware constituting the color verification server 101 is assumed to be a virtualized resource provided by the cloud computing platform 100, and does not need to correspond one-on-one to the hardware. In the present embodiment, the description is given on the assumption that the server operates in a cloud environment. However, a preferred implementation of the present disclosure does not necessarily require the color verification server 101 to be on the cloud computing platform 100. For example, the color verification server 101 may be implemented by a dedicated server including a physical CPU and a RAM. These hardware components can be changed according to the purpose of implementing the present disclosure.

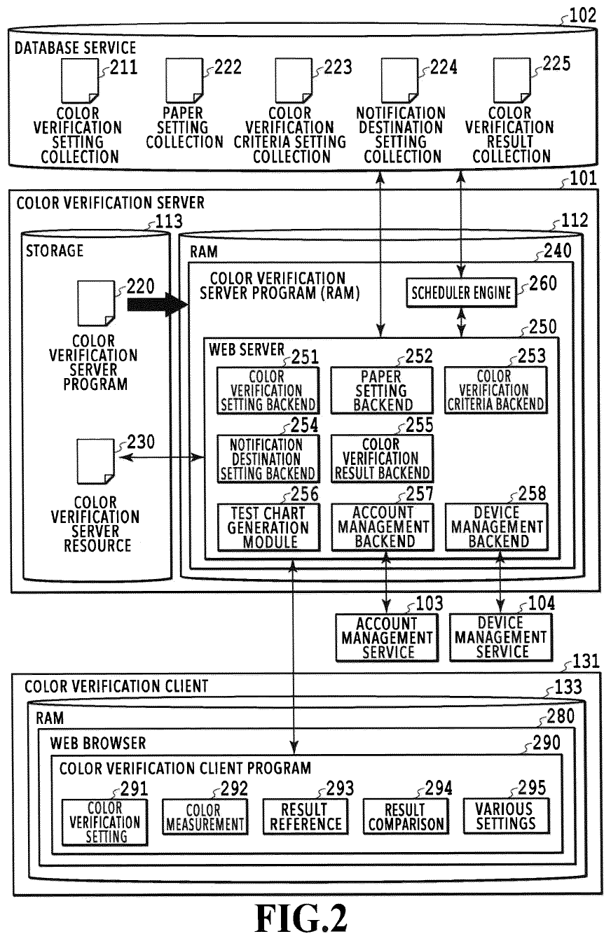

The database service 102 is a service for managing a database used by the color verification server 101. In the present embodiment, data managed by the Database service 102 is assumed to be data in the JSON format using NoSQL technology. In implementing the present disclosure, a relational database technology or the like may be used, instead of NoSQL technology. The database (collection) managed by the Database service 102 will be described in detail in FIG. 2.

The account management service 103 is a service which provides various information about a user account upon request from the color verification server 101 and performs notification to the user account. Specifically, the account management service 103 functions as a notification unit configured to notify a user of the information. For example, in a case where a work completion event of a preceding phase is not detected and a work time for the preceding phase has elapsed, a Scheduler Engine 260 to be described later receives a signal indicating that there is a delay in operation. The Scheduler Engine 260 requests the account management service 103 to notify that there is a delay in operation in the preceding phase. Upon requested by the Scheduler Engine 260, the account management service 103 notifies the user of the delay in operation in the preceding phase by sending an email to the user or displaying on a display 142. Specifically, the account management service 103 can send an email to a Mail Server 124 via the Internet 120, based on designated user account information. Alternatively, the account management service 103 can send a short message to a mobile phone _123 via the Internet 120 and a system of a mobile phone operator 122. In addition, the account management service 103 may send a notification to the user account via a service other than the color verification service, such as a bulletin board service. Furthermore, the account management service 103 may display the notified information on the display 142, a UI 156 of a printer 150, or a UI 161 of a controller 160.

The device management service 104 is a service for performing input/output control for printer devices and controllers. Specifically, the device management service 104 can obtain various states related to the printer 150 and a printer 170 from a controller 151 and the controller 160 via the Internet 120 and a Gateway 121. In response to a request from the color verification server 101, the device management service 104 can request the controller 151 and the controller 160 to perform control such as test chart printing and color adjustment.

The Internet 120 represents the concept of Internet connection. The mobile phone operator 122 represents the concept of an Internet connection service managed by the mobile phone operator. The mobile phone 123 represents a mobile terminal managed by the mobile phone operator 122 and contracted with a general consumer. The concept of the mobile terminal also includes a mobile phone, a smartphone, a tablet terminal, and the like. Although the easily imaginable mobile phone operator is described here as an example of an Internet connection service provider, the present disclosure is not limited thereto in terms of the preferred implementation of the present disclosure. To be more specific, in a case where an IoT operator provides Internet connection service using a satellite connection service or the like, rather than a mobile phone, an IoT device can be connected to the color verification system via the account management service 103 of the present disclosure. The above IoT device includes a head-mounted display, an in-vehicle system, or other devices.

A Gateway Server 121 is a server for connecting the Internet on the Internet 120 side to an intranet 130. The Mail Server 124 is a server for managing emails exchanged inside and outside the Internet 120 and the intranet 130. The intranet 130 is connected to the Internet 120 by the Gateway Server 121. A color verification client 131, the controller 151, and the controller 160 are interconnected on the intranet 130.

The color verification client 131 is a client PC used by an operator who performs color verification. The color verification client 131 includes a CPU 132, a RAM 133, a Storage 134, a Network Interface 135, an expansion I/F 136, and a graphic board 139. The CPU 132 is a central processing unit for executing a program deployed on the RAM 133 and for storing temporary data. The Storage 134 is a storage area for storing programs and data to be deployed on the RAM 133. The Storage 134 may be a hard disk drive (HDD), a solid state drive (SSD) or the like.

The Network Interface 135 is an interface for the CPU 132 to communicate with an internal device and an external device of the color verification client 131. The Network Interface 135 may be connected by a wired network or a wireless network.

The expansion I/F 136 is an interface for connecting hardware to the color verification client 131. In the present embodiment, a colorimeter 137, a colorimeter 138 with an automatic feed function, a keyboard 140, and a mouse 141 are connected to the expansion I/F 136. The colorimeter 137 does not have a feed function for measuring colors in a test chart. In color measurement using the colorimeter 137, all patches on a test chart to be subjected to the color measurement need to be manually designated. The colorimeter 138 has a feed function for measuring colors in a test chart. In color measurement using the colorimeter 138, all patches on a test chart to be subjected to the color measurement can be automatically read by setting the test chart. The keyboard 140 is a user interface for the operator to input numerical values and characters. The mouse 141 is a user interface for the operator to issue a work instruction by inputting a position, coordinates or the like on a screen.

The graphic board 139 is an expansion board for outputting images to the display 142 attached externally to the color verification client 131. The display 142 is a user interface for the color verification client 131 to display images to the operator. In the present embodiment, the keyboard 140, the. mouse 141, and the display 142 are described as separate components, but are not limited thereto. For example, an input device and a display device may be integrated using a touch panel.

The controller 151 is a controller unit for input/output control of the printer 150. The printer 150 is a printer device for printing on a print medium. In the present embodiment, an identifier “Printer X” is assigned to the printer 150. The printer 150 is a printer device including a feeder 152, an engine 153, a finisher 155, and a device UI 156. The feeder 152 is a unit for holding a plurality of print media (print sheets) and supplying the print media to the engine 153. A plurality of feeder units may be connected to one engine.

The engine 153 is a unit for printing on the print medium supplied from the feeder 152 using color materials and supplying the print medium to the finisher 155. The engine 153 may perform inkjet printing or electrophotographic printing. In the present embodiment, the engine 153 further includes an in-line sensor 154. The in-line sensor 154 has a function to measure the colors of the print result on a conveyance path (in-line) in a case of printing on the print medium by the engine 153. Although a configuration realized by a single engine is described in the present embodiment, a configuration in which a plurality of engines are connected, for example, may be adopted.

The finisher 155 is a unit for performing post-processing such as cutting, folding, or bookbinding on the print medium printed by the engine 153. Note that a configuration in which a plurality of finisher units are connected to one engine may also be adopted. The device UI 156 is a user interface for displaying a user interface screen (UI screen) for displaying a state of the printer 150. The device UI 156 may have an input function such as a button, a touch panel, and a keyboard, as well as an output function such as a buzzer and an LCD.

The controller 160 is a controller unit for controlling the printer 170. Here, differences from the controller 151 and the printer 150 will be mainly described. The controller 160 includes a controller UI 161. The controller UI 161 is a user interface for displaying a user interface screen for displaying a state of the printer 170.

In the present embodiment, an identifier “Printer Z” is assigned to the printer 170. The printer 170 is a printer device for printing on a print medium. The printer 170 includes a feeder 171, an engine 172, an inspection system 173, and a finisher 174. The engine 172 is a unit for printing on the print medium supplied from the feeder 171 using color materials and supplying the print medium to the inspection system 173. Note that the engine 172 is not equipped with an in-line sensor.

The inspection system 173 is a unit for verifying and inspecting the content printed on the print medium by the engine 153, including color measurement, on the conveyance path. In a case where the inspection system 173 determines that there is a quality problem as a result of inspection, an abnormality is notified to the controller 160, and the controller 160 stops printing, and the like. In a case where it is determined that there is no quality problem, the print medium is supplied to the finisher 174.

FIG. 2 is a software configuration diagram of the color verification system. In the present embodiment, descriptions of an operating system (OS), middleware, and a device driver for controlling each device will be omitted.

The database service 102 includes a color verification setting collection 211, a paper setting collection 222, a color verification criteria setting collection 223, a notification destination setting collection 224, and a color verification result collection 225. The color verification setting collection 211 is a collection for managing color verification settings including color measurement conditions. The paper setting collection 222 is a collection for managing paper settings. The color verification criteria setting collection 223 is a collection for managing color verification criteria settings including criteria for determining whether or not the color measurement result is suitable for actual printing. The notification destination setting collection 224 is a collection for managing an account to be notified of various events that occur in the color verification system, and notification conditions linked to each account. The color verification result collection 225 is a collection for managing a color verification result, which is the result of color verification.

Here, a color verification server program (RAM) 240 that runs on the color verification server 101 will be mainly described. The Storage 113 holds a color verification server program 220 and a color verification server resource 230. The CPU 111 executes the color verification server program 220 by deploying the program on the RAM 112 as the color verification server program (RAM) 240. The color verification server resource 230 stores a file such as HTML and an image provided by a color verification client program 290 to be described later upon request. The color verification server program (RAM) 240 includes a web server 250 and the Scheduler Engine 260.

The web server 250 includes a backend for performing various processing mainly upon request from outside the color verification server 101, and a module for performing processing mainly upon request from inside the color verification server 101. The web server 250 includes a color verification setting backend 251, a paper setting backend 252, a color verification criteria backend 253, a notification destination setting backend 254, and a color verification result backend 255. A unique URL is defined for each backend, and each processing is executed by accessing the URL by specifying a method such as POST, GET, or PUT.

The color verification setting backend 251 is a backend for obtaining a list of color verification settings from the color verification setting collection 211, and for creating, updating, and deleting the color verification settings. The paper setting backend 252 is a backend for obtaining a list of paper settings from the paper setting collection 222, and for creating, updating, and deleting the paper settings. The color verification criteria backend 253 is a backend for obtaining a list of color verification criteria settings from the color verification criteria setting collection 223, and for creating, updating, and deleting the color verification criteria settings on the color verification criteria setting collection 223. The notification destination setting backend 254 is a backend for obtaining a list of notification destination settings from the notification destination setting collection 224, and for creating, updating, and deleting the notification destination settings on the notification destination setting collection 224. The color verification result backend 255 is a backend for obtaining a list of color verification results from the color verification result collection 225, and for creating, updating, and deleting the color verification results on the color verification result collection 225.

The web server 250 also includes a test chart generation module 256, an account management backend 257, and a device management backend 258. The test chart generation module 256 is a module for generating a required test chart based on designated color verification settings. The account management backend 257 is a backend for obtaining information about a user account from the account management service 103, and for issuing a notification instruction to the user account. The device management backend 258 is a backend for obtaining information about a device from the device management service 104, and for requesting control of the device.

The Scheduler Engine 260 is a service for notifying the user account via the account management service 103 that a designated time has arrived. The Scheduler Engine 260 also controls timers and signals used in the present embodiment. The Scheduler Engine 260 receives timer setting requests from the CPU 111 and the CPU 132 via the web server 250, executes the requests, and returns the execution results as a response. This allows both the CPU 111 and the CPU 132 to set a timer to be started at a specific time and to cancel the set timer. The Scheduler Engine 260 can also receive a signal as a timer is started and notify the CPU 111 and the CPU 132. Describing this whole series of processing would make the explanation very complicated. Therefore, in the present embodiment, description will be given assuming that the CPU 111 and the CPU 132 can transparently set and cancel timers and receive signals.

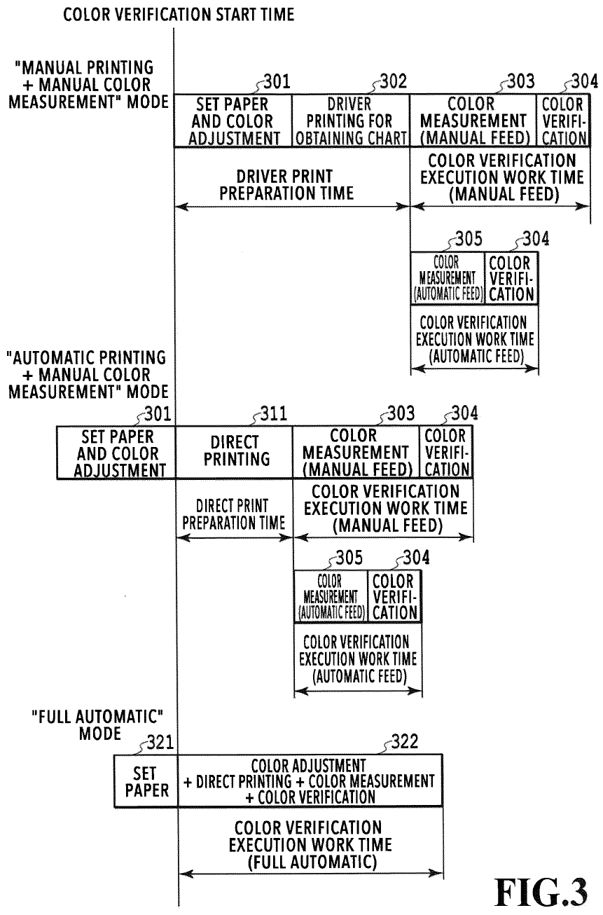

The Scheduler Engine 260 also has a plurality of functions. As an example, based on timers and signals controlled by the Scheduler Engine 260, a color verification task is divided into a color verification preparation phase and a color verification execution phase illustrated in FIG. 3 and managed. Therefore, the Scheduler Engine 260 functions as a management unit to divide the color verification task into two or more phases and manage each of the phases.

As illustrated in FIG. 3, a color verification preparation work time is represented by a driver print preparation time or a direct print preparation time. On the other hand, a color verification execution work time is represented by a color verification execution work time (manual feed), a color verification execution work time (automatic feed) or a color verification execution work time (full automatic). The Scheduler Engine 260 links the color verification preparation phase to the color verification preparation work time by controlling timers and signals. Similarly, the Scheduler Engine 260 links the color verification execution phase to the color verification execution work time. Therefore, the Scheduler Engine 260 also functions as a linking unit configured to link each phase to the corresponding work time.

Furthermore, the color verification preparation work time, such as the driver print preparation time or the direct print preparation time, and the color verification execution work time, such as the color verification execution work time (manual feed), the color verification execution work time (automatic feed) or the color verification execution work time (full automatic), may be fixed or variable. In a case where the color verification preparation work time and the color verification execution work time are fixed, the Scheduler Engine 260 sets an expiration time of each timer to a fixed value. In a case where the color verification preparation work time and the color verification execution work time are variable, the Scheduler Engine 260 requests the account management service 103 to notify the user of a recommended value of each work time based on the work time stored in the color verification result backend 255. Upon requested by the Scheduler Engine 260, the account management service 103 notifies the user of the recommended value of each work time by sending an email to the user or displaying the value on the display 142. The account management service 103 may display the recommended value of each work time on the UI 156 of the printer 150 or the UI 161 of the controller 160. The Scheduler Engine 260 may also automatically set the recommended value of each work time as a set value of a timer that notifies the color verification preparation work time and the color verification execution work time. The above-mentioned functions are part of the functions of the management unit of the Scheduler Engine 260.

Next, the color verification client program 290 that runs on the color verification client 131 will be described. The color verification client program 290 is a web application that runs on a web browser 280. The color verification client program 290 includes a color verification setting application 291, a color measurement application 292, a result reference application 293, a result comparison application 294, and a various setting application 295. The color verification setting application 291 is an application for performing color verification settings. The color measurement application 292 is an application for measuring colors. The result reference application 293 is an application for referring to the results of color verification. The result comparison application 294 is an application for comparing the color verification results. The various setting application 295 is an application for making various settings used in the system. These applications send and receive data related to color verification by sending requests to the color verification server 101 and receiving responses via network communication.

FIG. 3 is a conceptual diagram of a color verification chart print preparation time and a color verification execution work time. In the present embodiment, in a case of setting up periodic color verification, an administrator can select an operation mode to be used from among three operation modes: “manual printing+manual color measurement” mode, “automatic printing+manual color measurement” mode, and “full automatic” mode.

In the “manual printing+manual color measurement” mode, it is assumed that the operator sets paper and adjusts colors during a period 301 as a color verification start time has arrived, obtains print data for a test chart during a period 302, and performs printing using a printer driver. The time required for these preparations for color measurement is defined as a driver print preparation time.

In the “automatic printing+manual color measurement” mode, the operator sets paper in a feeder in the preliminary period 301 and also performs color adjustment for an engine. It is assumed that direct printing of the test chart is automatically performed in a period 311 as the color verification start time has arrived. The time required for these preparations for color measurement is defined as a direct print preparation time. In a case of an engine with small color fluctuations, such as an inkjet engine, for example, the color adjustment for the engine may be omitted.

In the “manual printing+manual color measurement” mode or the “automatic printing+manual color measurement” mode, there are roughly two methods for measuring the colors in a test chart. One method is color measurement by manual feed, which is performed in a period 303. The color measurement by manual feed is a method in which the operator manually measures the color of each patch on the test chart one by one. The other method is color measurement by automatic feed, which is performed in a period 305. The color measurement by automatic feed is a method in which, as the operator sets a test chart, a colorimeter automatically feeds the test chart and then measures the colors of the patches on the test chart. The times obtained by adding a color verification time performed in a period 304 to the time required for the color measurement by manual feed and the time required for the color measurement by automatic feed are defined as a color verification execution work time (manual feed) and a color verification execution work time (automatic feed), respectively.

In the “full automatic” mode, the operator sets paper in a preliminary preparing period 321. As the color verification start time has arrived, the color verification system automatically executes a series of processing including color adjustment, direct printing, color measurement, and color verification in a period 322. The time required for this series of color verification processing is defined as a color verification execution work time (full automatic).

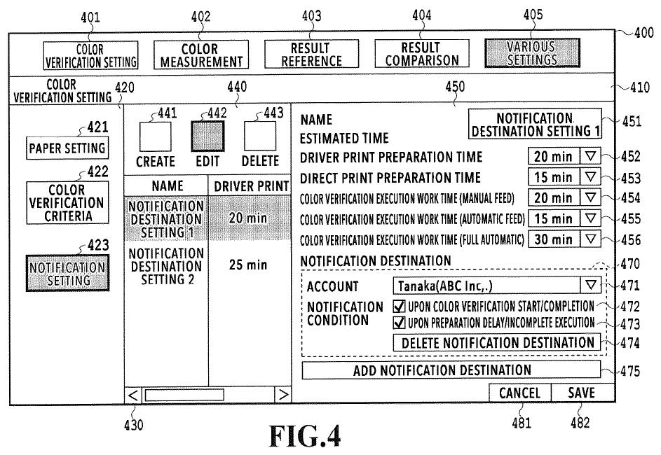

FIG. 4 is a diagram illustrating a notification destination setting screen of the various setting application 295. The notification destination setting screen is implemented in the various setting application 295 included in the color verification client program 290 running on the color verification client 131. The processing of the notification destination setting screen is executed by the CPU 132. The notification destination setting screen of the various setting application 295 includes an application switching bar 400 and a various setting view 410.

The application switching bar 400 is a user interface component for switching applications that is commonly provided to each application included in the color verification client program 290. Upon detection of the pressing of a switching button associated with each application, the CPU 132 displays a view of that application. For example, upon detection of the pressing of a color verification setting button 401, the CPU 132 displays a color verification setting view 900 of the color verification setting application. Upon detection of the pressing of a color measurement button 402, the CPU 132 displays a color measurement setting view 1800 of the color measurement application. Upon detection of the pressing of a result reference button 403, the CPU 132 displays a view of the result reference application. Upon detection of the pressing of a result comparison button 404, the CPU 132 displays a view of the result comparison application. Upon detection of the pressing of a various setting button 405, the CPU 132 displays the various setting view 410 of the various setting application.

The various setting view 410 includes a various setting switching panel 420, a notification destination setting list 430, a notification destination setting command panel 440, and a notification destination setting property 450. The various setting switching panel 420 is a panel for selecting a setting item to be set in the various setting application 295. Upon detection of the pressing of a paper setting button 421, the CPU 132 displays a screen for creating, editing, and deleting paper settings. Upon detection of the pressing of a color verification criteria button 422, the CPU 132 displays a screen for creating, editing, and deleting color verification criteria. Upon detection of the pressing of a notification destination setting button 423, the CPU 132 displays a screen for creating, editing, and deleting notification destination settings. The following description is given assuming that the notification destination setting button 423 1s pressed in FIG. 4.

The notification destination setting list 430 is a list for displaying a list of notification destination settings. Upon detection of the pressing of a button on any of the destination settings included in the destination setting list 430, the CPU 132 determines that the notification destination setting has been selected. The notification destination setting command panel 440 is a panel for issuing various work instructions for the selected notification destination setting. The notification destination setting command panel 440 includes a create button 441, an edit button 442, and a delete button 443.

Upon detection of the pressing of the create button 441, the CPU 132 displays the notification destination setting property 450 for creating a new notification destination setting. In this event, an ID attribute is assigned as an invalid value to the notification destination setting property 450. Upon detection of the pressing of the edit button 442, the CPU 132 displays the notification destination setting property 450 for editing the selected notification destination setting. In this event, the ID attribute of the selected notification destination setting is set as a valid value to the notification destination setting property 450. Upon detection of the pressing of the delete button 443, the CPU 132 displays a confirmation dialog to confirm whether or not to delete the selected notification destination setting.

The notification destination setting property 450 is a property screen used to create or edit a notification destination setting. Note that FIG. 4 illustrates an example where a notification destination setting “Notification destination setting 1” is selected, the edit button 442 is pressed, and the contents of “Notification destination setting 1” are being edited.

The notification destination setting property 450 includes a name text box 451, a driver print preparation time drop-down list 452, and a direct print preparation time drop-down list 453. The notification destination setting property 450 also includes a color verification execution work time (manual feed) drop-down list 454, a color verification execution work time (automatic feed) drop-down list 455, and a color verification execution work time (full automatic) drop-down list 456. The notification destination setting property 450 includes one or more notification conditions 470, and a notification destination add button 475. The notification destination setting property 450 further includes a cancel button 481 and a save button 482.

The name text box 451 is a text box for editing a name to be assigned to the notification destination setting currently being edited. The driver print preparation time drop-down list 452 is a drop-down list for selecting an estimated work time, assuming that a test chart will be printed by the printer driver, in the notification destination setting currently being edited. The direct print preparation time drop-down list 453 is a drop-down list for selecting an estimated work time, assuming that a test chart will be directly sent to the controller and printed, in the notification destination setting currently being edited. The color verification execution work time (manual feed) drop down list 454 is a drop-down list for selecting an estimated work time, assuming that a printed test chart will be manually fed for color measurement, in the notification destination setting currently being edited. The color verification execution work time (automatic feed) drop-down list 455 is a drop-down list for selecting an estimated work time, assuming that a printed test chart will be automatically fed for color measurement, in the notification destination setting currently being edited. The color verification execution work time (full automatic) drop-down list 456 is a drop-down list for selecting an estimated work time, assuming that color verification will be executed fully automatically, in the notification destination setting currently being edited. The concept of the estimated work time has already been described in the section of FIG. 3.

The notification conditions 470 are a group of setting items for setting the notification conditions for each account. The notification conditions 470 include a notification destination account drop-down list 471, a color verification start/completion notification condition check box 472, a color verification preparation delay/incomplete execution notification condition check box 473, a notification destination delete button 474, and a notification destination add button 475.

The notification destination account drop-down list 471 is a drop-down list for selecting an account to be the notification destination in the account setting. The color verification start/completion notification condition check box 472 is a check box for selecting whether or not to notify the account upon detection of the start or completion of color verification for the color verification setting for which the notification destination setting is selected. The color verification preparation delay/incomplete execution notification condition check box 473 is a check box for selecting whether or not to notify the account upon detection of a delay or incompletion of color verification preparation for the color verification setting for which the notification destination setting is selected. The notification destination delete button 474 is a button for deleting the account setting from the notification destination setting. The notification destination add button 475 is a button for adding a new account setting to the notification destination setting. As described above, in the present embodiment, a plurality of accounts are held by linking notification conditions to one notification destination setting.

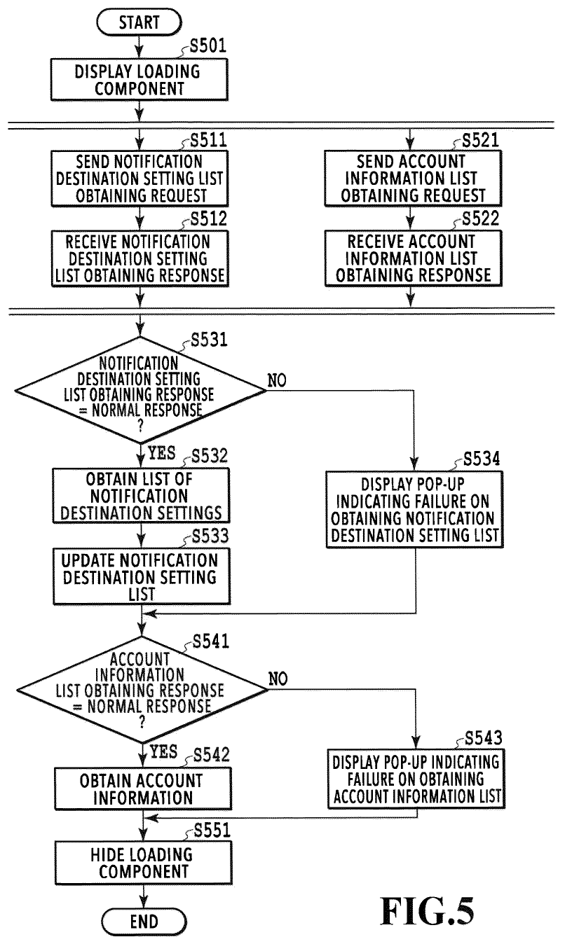

The cancel button 481 is a button for closing the notification destination setting property 450 without saving the notification destination setting. The save button 482 is a button for saving the notification destination setting. The notification destination setting save processing will be described in detail in the section of FIG. 5.

FIG. 5 is a flowchart of processing for displaying the notification destination setting screen of the various setting application 295. A program for executing the processing of this flowchart is implemented in the various setting applications 295, and the CPU 132 executes the program.

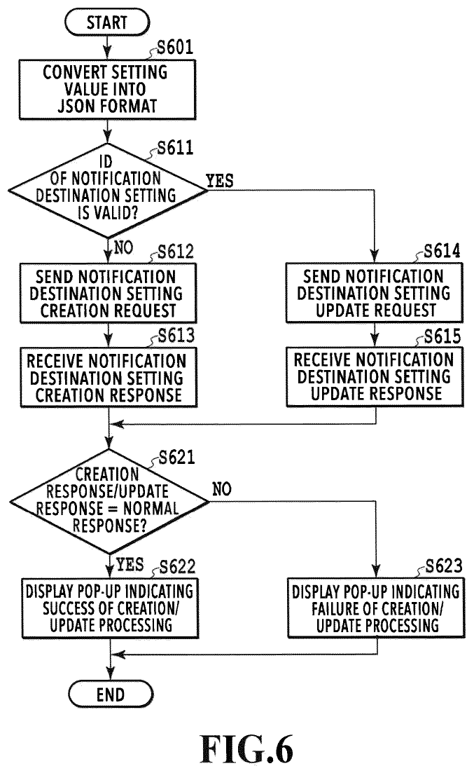

In S501, the CPU 132 displays a loading component (not illustrated) on the various setting view 410 in a superimposed manner. Here, the loading component refers to a component for which “Loading data” or the like is displayed on the screen while data is being loaded. While the loading component is superimposed and displayed, the CPU 132 does not accept any operations on other components on the various setting view 410. Next, the CPU 132 executes the processing of S511 and S521 in parallel. In S511, the CPU 132 sends a notification destination setting list obtaining request to the color verification server 101. In S512, the CPU 132 receives a notification destination setting list obtaining response from the color verification server 101. In S521, the CPU 132 sends an account information list obtaining request to the color verification server 101. In S522, the CPU 132 receives an account information list obtaining response from the color verification server 101. The operation on the color verification server 101 side will be described later in the section of FIG. 6. The CPU 132 waits until the processing of both S512 and S522 is completed.

In S531, the CPU 132 branches the processing based on the notification destination setting list obtaining response. If the notification destination setting list obtaining response is a normal response, the processing proceeds to S532. If the notification destination setting list obtaining response is an abnormal response, the processing proceeds to S534. In S532, the CPU 132 obtains a notification destination setting list from the notification destination setting list obtaining response. In S533, the CPU 132 uses the obtained notification destination setting list to update the notification destination setting list 430. In S534, the CPU 132 displays a pop-up indicating failure on obtaining the notification destination setting list on the various setting view 410. Here, the pop-up is a component for displaying information, warning, or error on the screen for a certain period of time. The same applies to pop-up display described in the following description.

In S541, the CPU 132 branches the processing based on the account information list obtaining response. In a case where the account information list obtaining response is a normal response, the processing proceeds to S542. In a case where the account information list obtaining response is an abnormal response, the processing proceeds to S543. In S542, the CPU 132 obtains account information from the account information list obtaining response. The account information is used as a selection item in the notification destination account drop-down list 471. In S543, the CPU 132 displays a pop-up indicating failure on obtaining the account information list. In S551, the CPU 132 hides the loading component from the various setting view 410. This triggers the CPU 132 to accept operations on the components on the various setting view 410.

FIG. 6 is a flowchart of save processing executed on the notification destination setting screen of the various setting application 295. A program for executing the processing of this flowchart is implemented in the various setting application 295, and the CPU 132 executes the program.

In S601, the CPU 132 converts a setting value set on the notification destination setting property 450 into the JSON format, in order to notify the setting value to the notification destination setting backend 254. Although the JSON format is used in the present embodiment, which is widely used as one of the data formats, other formats can also be used in implementing the present disclosure. For example, any format can be used, such as the XML format or the YAML format.

In S611, the CPU 132 branches the processing based on the ID attribute of the notification destination setting in the notification destination setting property 450. In a case where the ID of the notification destination setting is invalid, the processing proceeds to S612. In a case where the ID of the notification destination setting is valid, the processing proceeds to S614.

The invalid ID of the notification destination setting means creating a new notification destination setting. In S612, the CPU 132 sends a notification destination setting creation request to the color verification server 101. In S613, the CPU 132 receives a notification destination setting creation response from the color verification server 101. The valid ID of the notification destination setting means updating the existing notification destination setting. In S614, the CPU 132 sends a notification destination setting update request to the color verification server 101. In S615, the CPU 132 receives a notification destination setting update response from the color verification server 101.

In S621, the CPU 132 branches the processing based on the notification destination setting creation response or the notification destination setting update response. In a case where the notification destination setting creation response or the notification destination setting update response is a normal response, the processing proceeds to S622. In a case where the notification destination setting creation response or the notification destination setting update response is an abnormal response, the processing proceeds to S623. In S622, the CPU 132 displays a pop-up indicating success of the notification destination setting creation processing or a pop-up indicating success of the notification destination setting update processing for the notification destination setting property 450. In S623, the CPU 132 displays a pop-up indicating failure of the notification destination setting creation processing or a pop-up indicating failure of the notification destination setting update processing for the notification destination setting property 450.

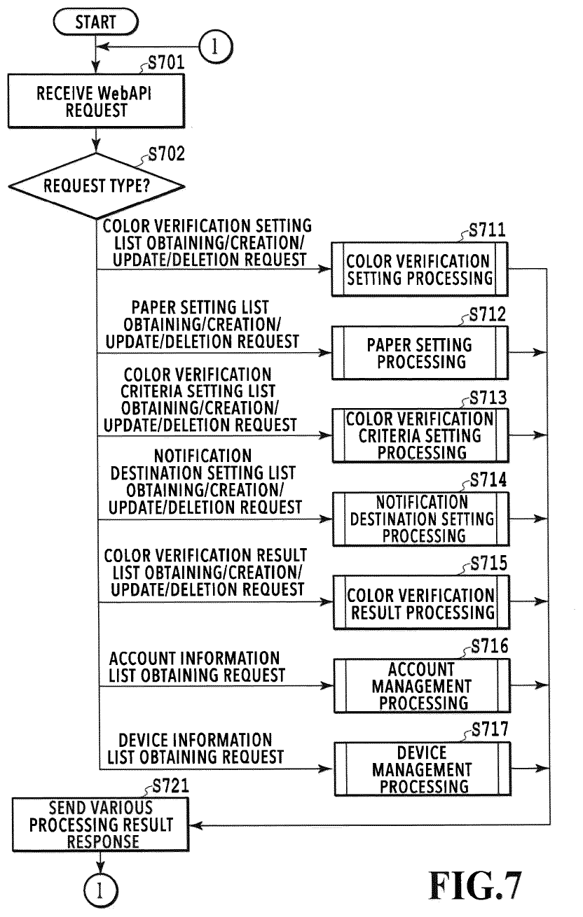

FIG. 7 is a flowchart illustrating main loop processing of the web server 250. A program for executing the processing of this flowchart is implemented in the color verification server program (RAM) 240, and the CPU 111 executes the program. In the flowcharts of FIGS. 5 to 7 and those subsequent thereto, requests from the color verification client 131 to the color verification server 101 and responses to these requests are executed by the processing of this flowchart. To simplify the explanation, only important parts of the present embodiment will be described.

In S701, the CPU 111 uses an HTTP protocol or the like to receive a Web API request from the color verification client 131. The Web API request includes a resource name such as a “backend name” and a method designation for the resource. As for the method designation, for example, GET designation means a list obtaining request. PUT designation means a creation request. POST designation means an update request. DELETE designation means a deletion request. A processing target is designated by a URL (Uniform Resource Locator) and a resource name. The resource name may be, for example, “/colortest” for color verification setting, “/substrate” for paper setting, or the like. The CPU 111 determines a request type from the resource name and the method designation.

In S702, the CPU 111 branches the processing based on the request type. In a case where the request type is a request for color verification setting, the processing proceeds to S711. In a case where the request type is a request for paper setting, the processing proceeds to S712. In a case where the request type is a request for color verification criteria setting, the processing proceeds to S713. In a case where the request type is a request for notification destination setting, the processing proceeds to S714. In a case where the request type is a request for color verification result, the processing proceeds to S715. In a case where the request type is a request for account information, the processing proceeds to S716. In a case where the request type is a request for device information, the processing proceeds to S717.

In S711, the CPU 111 executes color verification setting processing. In S712, the CPU 111 executes paper setting processing. In S713, the CPU 111 executes color verification criteria setting processing. In S714, the CPU 111 executes notification destination setting processing. In S715, the CPU 111 executes color verification result processing. In S716, the CPU 111 executes account management processing. The CPU 111 obtains necessary information from the account management service 103 via the account management backend 257, and responds to the obtained information. In S717, the CPU 111 executes device management processing. The CPU 111 obtains necessary information from the device management service 104 via the device management backend 258, and responds to the obtained information.

In S721, the CPU 111 transmits the execution result of each processing as various processing result response to the source of the Web API request. The CPU 111 sets the contents of the response in each processing. Specifically, in a case where the processing is completed normally, the CPU 111 responds by setting a normal response to a status code. On the other hand, in a case where the processing is not completed normally, the CPU 111 responds by setting an abnormal response to the status code. In a case where the request is about obtaining a list, the CPU 111 assigns the list obtaining result to the response. Upon completion of the processing of S721, the CPU 111 waits to receive a new Web API request.

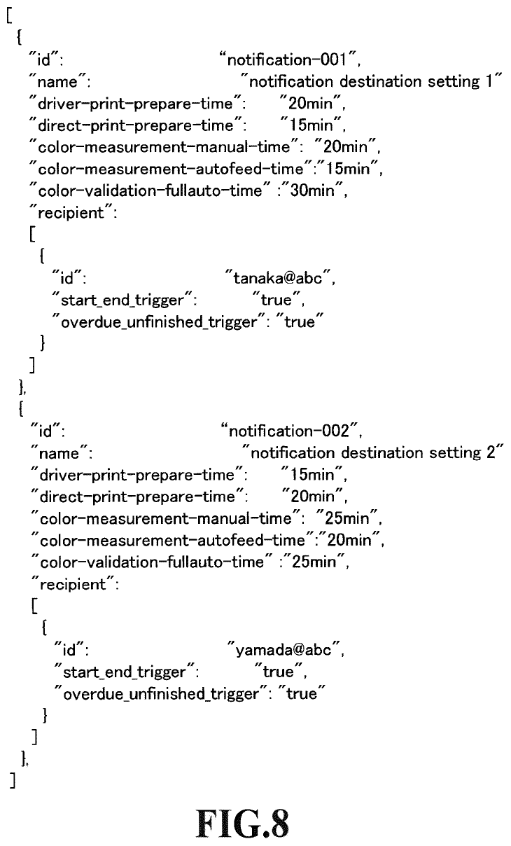

FIG. 8 illustrates a data structure of a notification destination setting list. The notification destination setting list can hold a plurality of notification destination settings. The notification destination setting can hold a plurality of notification conditions. An id attribute of a notification destination setting is an identifier attribute for uniquely determining the notification destination setting. A name attribute of a notification destination setting is an attribute indicating name information of the notification destination setting, which is set arbitrarily by the administrator. A driverprint-prepare-time attribute of a notification destination setting is an attribute indicating a driver print preparation time. A direct-print-prepare-time attribute of the notification destination setting is an attribute indicating a direct print preparation time. A color-measurement-manual-time attribute of the notification destination setting is an attribute indicating a color verification execution work time (manual feed). A colormeasurement-autofeed-time attribute of the notification destination setting is an attribute indicating a color verification execution work time (automatic feed). A colorvalidation-fullauto-time attribute of the notification destination setting is an attribute indicating a color verification execution work time (full automatic). A recipient attribute of the notification destination setting is an attribute indicating the notification condition.

The id attribute of the notification condition is an attribute for uniquely determining notification destination account information. For example, the id attribute of the notification condition may be, for example, an email address or an account name. A start_end_trigger attribute of the notification condition is an attribute for designating whether or not to notify the account upon start/completion of color verification. An overdue_unfinished_trigger attribute of the notification condition is an attribute for designating whether or not to notify the account linked to the notification destination account information in a case where color verification preparation is delayed or color verification is incomplete.

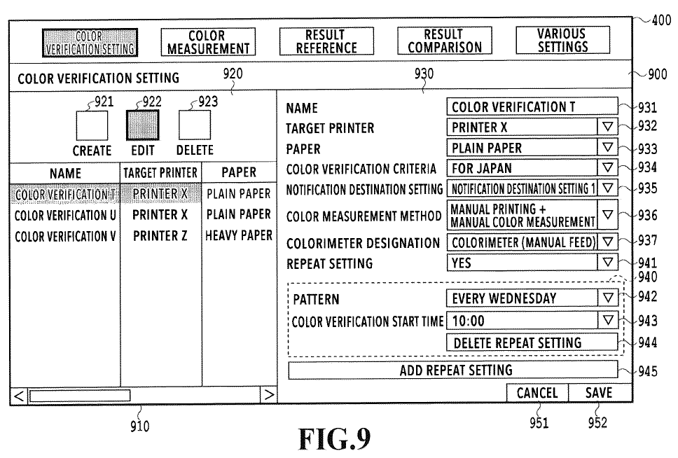

FIG. 9 illustrates a screen of the color verification setting application 291. The color verification setting application screen includes the application switching bar 400 and a color verification setting view 900. The application switching bar 400 has already been described in FIG. 4, and thus description thereof will be omitted. The description of the application switching bar 400 will also be omitted in the following description of screens.

The color verification setting view 900 includes a color verification setting list 910, a color verification setting command panel 920, and a color verification setting property 930. The color verification setting list 910 is a list display component for displaying a list of color verification settings. Upon detection of the pressing of a button on any of the color verification settings included in the color verification setting list 910, the CPU 132 determines that the color verification setting has been selected.

The color verification setting command panel 920 is a panel for issuing various work instructions for the selected color verification setting. The color verification setting command panel 920 includes a create button 921, an edit button 922, and a delete button 923. Upon detection of the pressing of the create button 921, the CPU 132 displays a color verification setting property 930 to newly create the selected color verification setting. In this event, an ID attribute is assigned as an invalid value to the color verification setting property 930. Upon detection of the pressing of the edit button 922, the CPU 132 displays the color verification setting property 930 to edit the selected color verification setting. In this event, the ID attribute of the selected color verification setting is set as a valid value in the color verification setting property 930. Upon detection of the pressing of the delete button 923, the CPU 132 displays a confirmation dialog to confirm the deletion of the selected color verification setting.

The color verification setting property 930 is a property screen used to create or edit the selected color verification setting. It is preferable that the color verification setting property 930 switches between display and hide according to instructions from the color verification setting command panel 920. For convenience of explanation, FIG. 9 illustrates a state where the edit button 922 is pressed with color verification T selected, and the color verification setting property 930 is displayed.

The color verification setting property 930 includes a name text box 931, a target printer drop-down list 932, a paper drop-down list 933, and a color verification criteria drop-down list 934. The color verification setting property 930 also includes a notification destination setting drop-down list 935, a color measurement method drop-down list 936, a colorimeter designation drop-down list 937, and a repeat setting drop-down list 941.

The color verification setting property 930 has one or more repeat pattern settings 940 in a case where the repeat setting is set to “Yes” in the repeat setting drop-down list 941. The repeat pattern setting 940 includes a pattern setting drop-down list 942, a color verification start time picker 943, and a repeat setting delete button 944. The color verification setting property 930 includes a repeat setting add button 945, a cancel button 951, and a save button 952.

The name text box 931 is a text box for editing name information to be assigned to the color verification setting currently being edited. The target printer drop down list 932 is a drop-down list for selecting a target printer for the color verification setting currently being edited. The paper drop-down list 933 is a drop-down list for selecting target paper for the color verification setting currently being edited. The color verification criteria drop-down list 934 is a drop-down list for selecting target color verification criteria for the color verification setting currently being edited. The notification destination setting drop-down list 935 is a drop-down list for selecting a notification destination for the color verification setting currently being edited. The color measurement method drop-down list 936 is a drop-down list for selecting a color measurement method to be used for the color verification setting currently being edited. In the present embodiment, the operation mode can be selected from among “manual printing+manual color measurement” mode, “automatic printing+manual color measurement” mode, and “full automatic” mode. The colorimeter designation drop down list 937 is a drop-down list for selecting a colorimeter to be used for the color verification setting currently being edited. In the present embodiment, the colorimeter to be used can be selected from among a colorimeter (manual feed), a colorimeter (automatic feed), an inline sensor, and an inspection system.

The repeat setting drop-down list 941 is a drop-down list for selecting whether to use a repeat setting in the color verification setting currently being edited. The pattern setting drop-down list 942 is a drop-down list for selecting in what pattern the execution is repeated in the repeat pattern setting. In the present embodiment, a day of the week from Monday to Sunday can be selected. The color verification start time picker 943 is a picker for designating a start time in the repeat pattern setting. The repeat setting delete button 944 is a button for deleting the repeat pattern setting. The repeat setting add button 945 is a button for adding a new repeat pattern setting in the color verification setting currently being edited. The cancel button 951 is a button for closing the color verification setting property 930 without saving the color verification setting currently being edited. The save button 952 is a button for saving the color verification setting currently being edited.

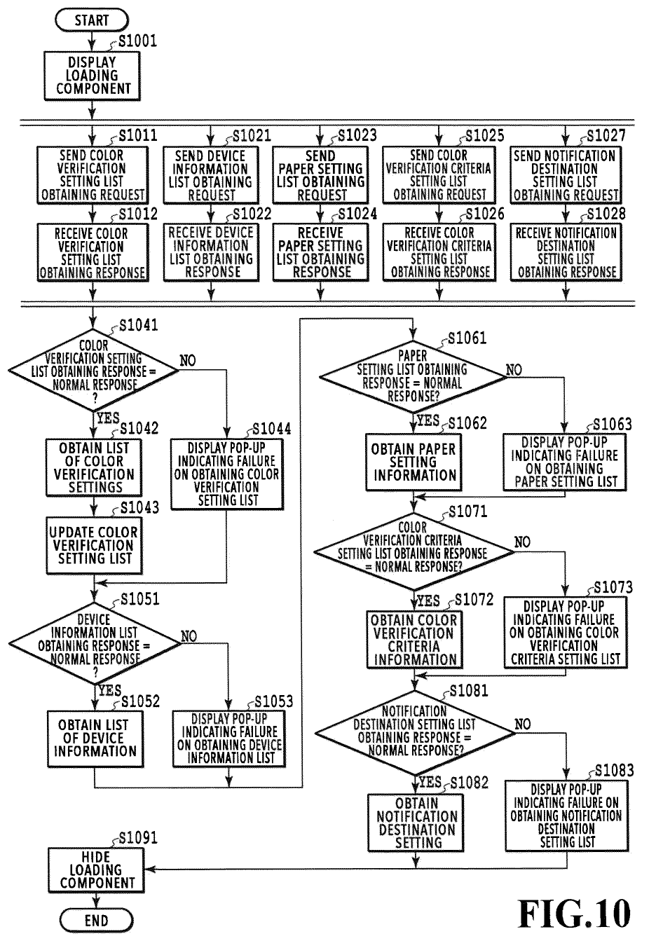

FIG. 10 is a flowchart of processing in a case of displaying the screen of the color verification setting application 291. A program for executing the processing of this flowchart is implemented in the color verification setting application 291, and the CPU 132 executes the program.

In S100l, the CPU 132 displays a loading component on the color verification setting view 900 in a superimposed manner. While the loading component is superimposed and displayed, the CPU 132 does not accept any operations on other components on the color verification setting view 900. Once the loading component is superimposed and displayed, the CPU 132 executes the processing of S1011, S1021, S1023, S1025, and S1027 in parallel.

In S1011, the CPU 132 sends a color verification setting list obtaining request to the color verification server 101. In S1012, the CPU 132 receives a color verification setting list obtaining response from the color verification server 101. In S1021, the CPU 132 sends a device information list obtaining request to the color verification server 101. In S1022, the CPU 132 receives a device information list obtaining response from the color verification server 101. In S1023, the CPU 132 sends a paper setting list obtaining request to the color verification server 101. In S1024, the CPU 132 receives a paper setting list obtaining response from the color verification server 101. In S1025, the CPU 132 sends a color verification criteria setting list obtaining request to the color verification server 101. In S1026, the CPU 132 receives a color verification criteria setting list obtaining response from the color verification server 101. In S1027, the CPU 132 sends a notification destination setting list obtaining request to the color verification server 101. In S1028, the CPU 132 receives a notification destination setting list obtaining response from the color verification server 101. Then, the CPU 132 waits until all the processing of S1012, S1022, S1024, S1026, and S1028 is completed.

In S1041, the CPU 132 branches the processing based on the color verification setting list obtaining response. In a case where the color verification setting list obtaining response is a normal response, the processing proceeds to S1042. In a case where the color verification setting list obtaining response is an abnormal response, the processing proceeds to S1043. In S1042, the CPU 132 obtains a list of color verification settings from the color verification setting list obtaining response. In S1043, the CPU 132 reflects the list of color verification settings in the color verification setting list 910. In S1044, the CPU 132 displays a pop-up indicating failure on obtaining the color verification setting list.

In S1051, the CPU 132 branches the processing based on the device information list obtaining response. In a case where the device information list obtaining response is a normal response, the processing proceeds to S1053. In a case where the device information list obtaining response is an abnormal response, the processing proceeds to S1054. In S1053, the CPU 132 obtains a device information list from the device information list obtaining response. The device information list is used as a selection item in the target printer drop-down list 932. In S1054, the CPU 132 displays a pop-up indicating failure on obtaining the device information list.

In S1061, the CPU 132 branches the processing based on the paper setting list obtaining response. In a case where the paper setting list obtaining response is a normal response, the processing proceeds to S1062. In a case where the paper setting list obtaining response is an abnormal response, the processing proceeds to S1063. In S1062, the CPU 132 obtains paper setting information from the paper setting list obtaining response. The paper setting information is used as a selection item in the paper drop-down list 933. In S1063, the CPU 132 displays a pop-up indicating failure on obtaining the paper setting list.

In S1071, the CPU 132 branches the processing based on the color verification criteria setting list obtaining response. In a case where the color verification criteria setting list obtaining response is a normal response, the processing proceeds to S1072. In a case where the color verification criteria setting list obtaining response is an abnormal response, the processing proceeds to S1073. In S1072, the CPU 132 obtains color verification criteria information from the color verification criteria setting list obtaining response. The color verification criteria information is used as a selection item in the color verification criteria drop-down list 934. In S1073, the CPU 132 displays a pop-up indicating failure on obtaining the color verification criteria setting list.

In S1081, the CPU 132 branches the processing based on the notification destination setting list obtaining response. In a case where the notification destination setting list obtaining response is a normal response, the processing proceeds to S1082. In a case where the notification destination setting list obtaining response is an abnormal response, the processing proceeds to S1083. In S1082, the CPU 132 obtains a notification destination setting from the notification destination setting list obtaining response. The notification destination setting is used as a selection item in the notification destination setting drop-down list 935. In S1083, the CPU 132 displays a pop-up indicating failure on obtaining the notification destination setting list.

In S1091, the CPU 132 hides the loading component on the color verification setting view 900. This allows the CPU 132 to accept operations on the components in the color verification setting view 900.

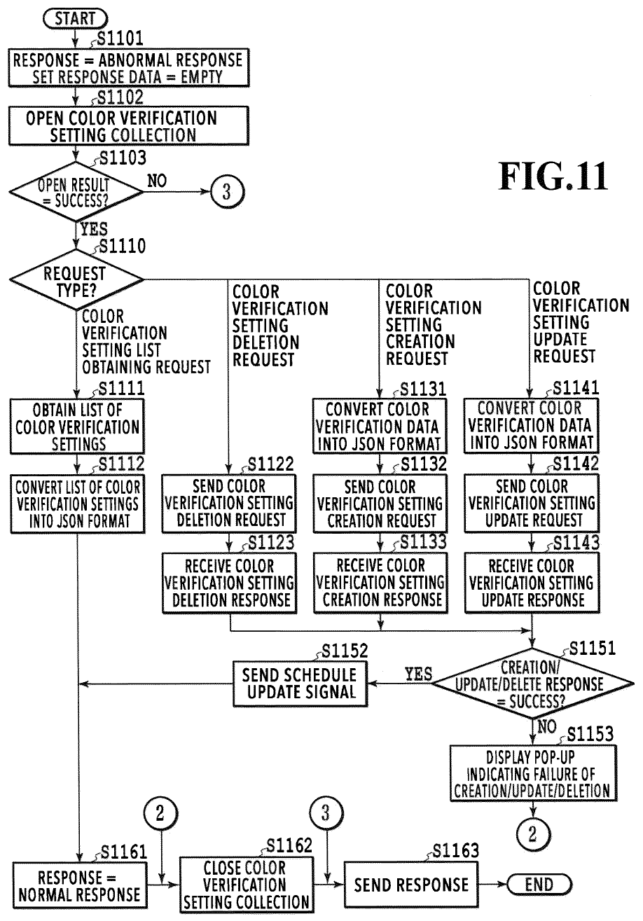

FIG. 11 is a flowchart of color verification setting processing. A program for executing the processing of this flowchart is implemented in the color verification setting backend 251, and the CPU 111 executes the program. In S1101, the CPU 111 initializes a response to an abnormal response and response data to empty. In S1102, the CPU 111 opens the color verification setting collection 211.

In S1103, the CPU 111 branches the processing based on the open result. If the open result is successful, the processing proceeds to S1110. In a case where the open result is unsuccessful, the processing proceeds to S1163. In S1110, the CPU 111 branches the processing according to the request type. In a case where the request type is a color verification setting list obtaining request, the processing proceeds to S1111. In a case where the request type is a color verification setting deletion request, the processing proceeds to S1122. In a case where the request type is a color verification setting creation request, the processing proceeds to S1131. In a case where the request type is a color verification setting update request, the processing proceeds to S1141.

In S1111, the CPU 111 obtains each color verification setting list from the color verification setting collection 211. In S1112, the CPU 111 converts the color verification setting list into the JSON format and sets the converted data in response data. In S1161, the CPU 111 sets the response to a normal response. In S1162, the CPU 111 closes the color verification setting collection 211. In S1163, the CPU 111 sends the response and the response data to the request source.

In S1122, the CPU 111 transmits a color verification setting deletion request to the color verification setting collection 211. In S1123, the CPU 111 receives a color verification setting deletion response. In S1151, the CPU 111 branches the processing based on the response. In a case where the response is successful, the processing proceeds to S1152. In a case where the response is unsuccessful, the processing proceeds to S1153. In S1152, the CPU 111 sends a schedule update signal to the Scheduler Engine 260, and the processing proceeds to S1161. Subsequently, the processing from S1161 described above is performed. In S1153, the CPU 111 displays a deletion failure pop-up, and the processing proceeds to S1162. Subsequently, the processing from S1162 described above is performed.

In S1131, the CPU 111 interprets the color verification setting in the JSON format. In S1132, the CPU 111 sends a color verification setting creation request to the color verification setting collection 211. In S1133, the CPU 111 receives a color verification setting creation response from the color verification setting collection 211. Subsequently, the processing from S1151 described above is performed.

In S1141, the CPU 111 interprets the color verification setting in the JSON format. In S1142, the CPU 111 sends a color verification setting update request to the color verification setting collection 211. In S1143, the CPU 111 receives a color verification setting update response from the color verification setting collection 211. Subsequently, the processing from S1151 described above is performed.

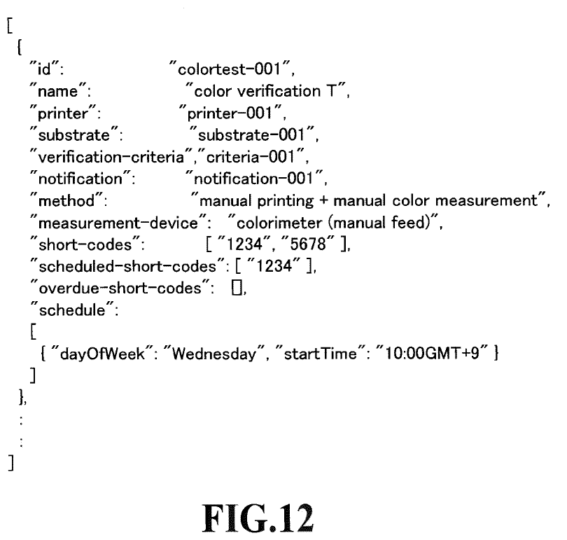

FIG. 12 illustrates a data structure of a color verification setting list. The color verification setting list can hold a plurality of color verification settings. An id attribute of a color verification setting is used to uniquely identify the color verification setting. A name attribute of a color verification setting indicates name information of the color verification setting, which is arbitrarily set by the administrator. A printer attribute of a color verification setting indicates a target printer of the color verification setting. A substrate attribute of a color verification setting indicates paper of the color verification setting. A verification-criteria attribute of a color verification setting indicates color verification criteria of the color verification setting. A notification attribute of a color verification setting indicates a notification destination setting of the color verification setting. A method attribute of a color verification setting indicates a color measurement method of the color verification setting. A measurement-device attribute of a color verification setting indicates a colorimeter designation of the color verification setting. A short-codes attribute of a color verification setting indicates a short code associated with the color verification setting. Here, the short code indicates a unique identifier assigned to each color verification task. In the present embodiment, the short code is expressed as a four-digit decimal number. A plurality of color verification tasks are linked to one color verification setting, and a part of chart data is linked to each color verification task. By inputting a short code upon color measurement, the color verification task is associated with the color verification setting, and input of various color measurement conditions can be omitted. By printing a short code on the chart data, the short code is associated with a color patch printed on a print medium. A scheduled-short-codes attribute of a color verification setting indicates a short code associated with chart data generated from a schedule of the color verification setting. An overdue-short-code attribute of a color verification setting indicates a target short code that has exceeded the estimated work time, among the short codes associated with the color verification setting.

A schedule attribute indicates a repeat pattern setting for the color verification setting. A dayOfWeek attribute of a repeat pattern indicates a pattern of the repeat setting. A startTime attribute of the repeat pattern indicates a color verification start time for the repeat setting.

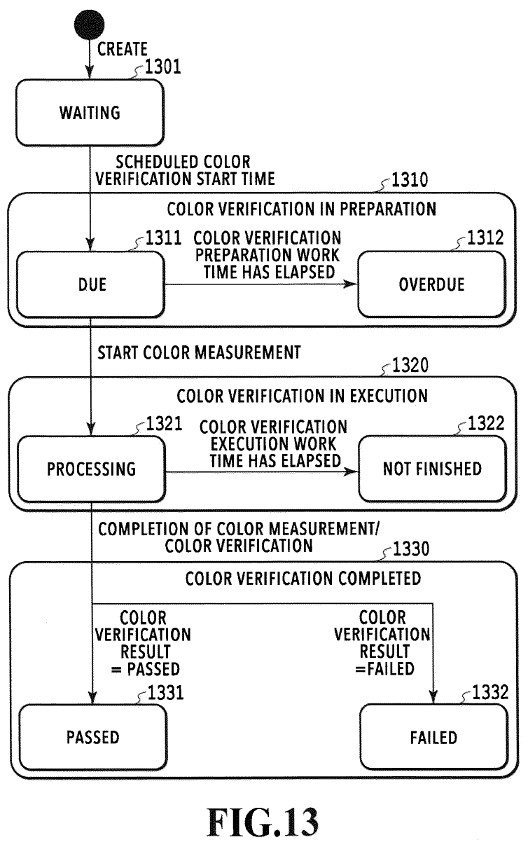

FIG. 13 is a state transition diagram of a color verification task in the present embodiment. As a color verification setting is created by the administrator, a color verification task is conceptually generated based on repeat pattern information registered with the color verification setting. However, in the present embodiment, description is given of a configuration in which a color verification task is generated using a timer that starts at a specified time, without creating data related to each color verification task.

An initial value of the color verification task is a Waiting state 1301. As a scheduled color verification start time registered with the schedule has arrived, the color verification task shifts to a Due state 1311 in a color verification in-preparation state 1310. As a color verification preparation work time has elapsed in the color verification task in the Due state 1311, the color verification task shifts to an Overdue state 1312.

As the operator starts color measurement for the color verification task in the color verification in-preparation state 1310, the color verification task shifts to a Processing state 1321 in a color verification in-execution state 1320. As a color verification execution work time has elapsed in the color verification task in the Processing state 1321, the color verification task shifts to a Not Finished state 1322.

Upon completion of the color measurement and color verification in the color verification task in the color verification in-execution state 1320, the color verification task shifts to a color verification complete state 1330. At this time, in a case where the color measurement result meets the color verification criteria, the color verification result is judged as Passed, and the color verification task shifts to a Passed state 1331. On the other hand, in a case where the color measurement result does not meet the color verification criteria, the color verification result is judged as Failed, and the color verification task shifts to a Failed state 1332.

Here, a supplementary description is given of the features of the present disclosure. In the present disclosure, there are two estimated work times: the color verification preparation work time and the color verification execution work time. Once work of the color verification preparation phase and work of the color verification execution phase are started, a work start event is notified to a predetermined notification destination, and a work progress is managed. Furthermore, as the work of the color verification preparation phase and the work of the color verification execution phase are completed within the respective estimated work times, a work completion event is notified to the predetermined notification destination. On the other hand, in a case where the respective estimated work times are exceeded, a transition is made to a state different from a normal state. In this case, since the work completion event is not notified to the predetermined notification destination, the user is notified that the work of the color verification preparation phase or the work of the color verification execution phase is unfinished.

Compared to a case of the related art where the determination is made simply based on the total estimated work time, the present disclosure allows for more detailed state management. For example, a state in which color measurement has not been started and a state in which color measurement has been started but not completed can be managed as different states. In this way, by dividing a task into phases (subtasks), the administrator can grasp a work delay on a task-by-task basis. Furthermore, the operator can also notice the work delay early, and thus can start recovery work early for the work delay.

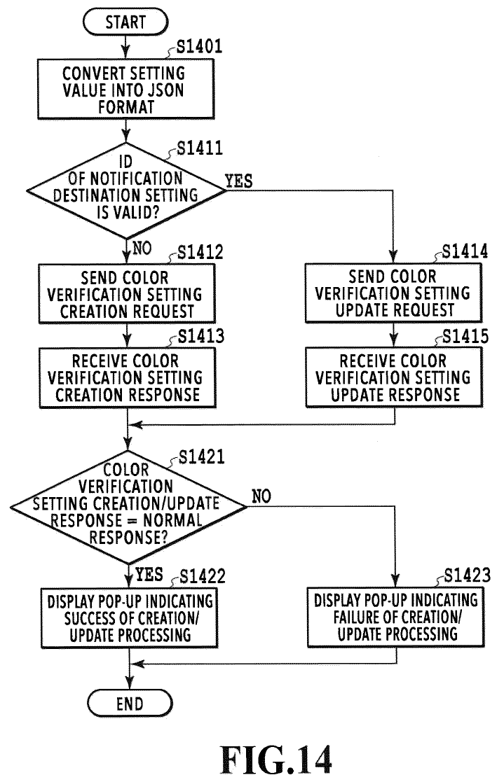

FIG. 14 is a flowchart of processing for saving the settings of the color verification setting application 291. A program for executing the processing of this flowchart is implemented in the color verification setting application 291, and the CPU 132 executes the program.

In S1401, the CPU 132 converts the color verification setting displayed on the color verification setting property 930 into the JSON format. In S1411, the CPU 132 checks the ID of the color verification setting set in the displayed color verification setting property 930. In a case where the ID of the color verification setting is invalid, that is, a new color verification setting is to be created, the processing proceeds to S1412. In a case where the ID of the color verification setting is valid, that is, the existing color verification setting is to be updated, the processing proceeds to S1414.

In S1412, the CPU 132 sends a color verification setting creation request to the color verification server 101. In S1413, the CPU 132 receives a color verification setting creation response from the color verification server 101. In S1414, the CPU 132 sends a color verification setting update request to the color verification server 101. In S1415, the CPU 132 receives a color verification setting update response from the color verification server 101.

In S1421, the CPU 132 branches the processing according to the color verification setting creation response or the color verification setting update response. In a case where the response is a normal response, the processing proceeds to S1422. In a case where the response is an abnormal response, the processing proceeds to S1423. In S1422, the CPU 132 displays a pop-up indicating success of the color verification setting creation processing or a pop-up indicating success of the color verification setting update processing. In S1423, the CPU 132 displays a pop-up indicating failure of the color verification setting creation processing or a pop-up indicating failure of the color verification setting update processing.

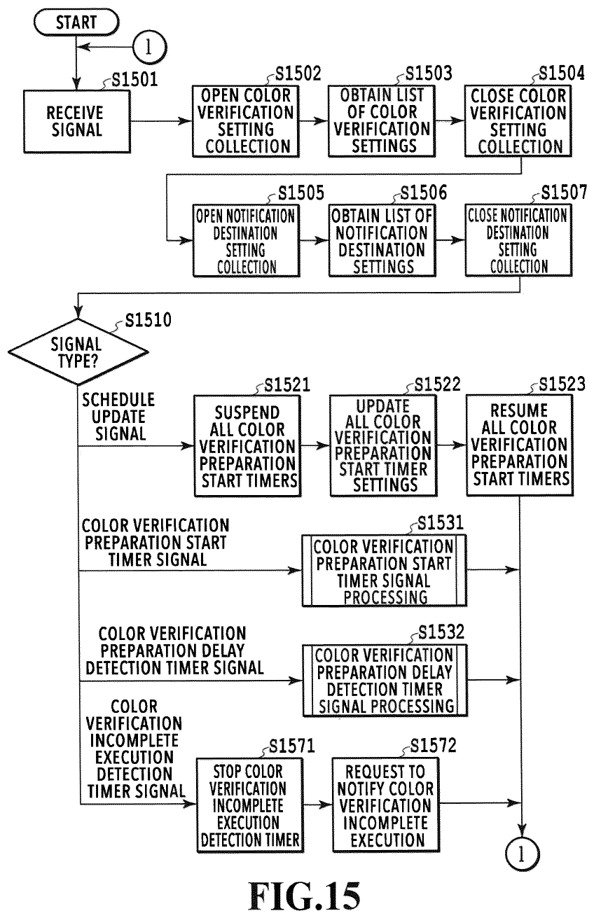

FIG. 15 illustrates a main loop of the Scheduler Engine 260. A program for executing the processing of this flowchart is implemented in the Scheduler Engine 260, and the CPU 111 executes the program. In S1501, CPU 111 receives a new signal. If there is no signal, the CPU 111 waits for a new signal to be generated. Once a new signal is received, the processing proceeds to S1502.

In S1502, the CPU 111 opens a color verification setting collection. In S1503, the CPU 111 obtains a list of color verification settings from the color verification collection. In S1504, the CPU 111 closes the color verification setting collection. In S1505, the CPU 111 opens a notification destination setting collection. In S1506, the CPU 111 obtains a list of notification destination settings from the notification destination setting collection. In S1507, the CPU 111 closes the notification destination setting collection.

In S1510, the CPU 111 switches the processing depending on the type of the received signal. In a case where the signal type is a schedule update signal, the processing proceeds to S1521. In a case where the signal type is a color verification preparation start timer signal, the processing proceeds to S1531. In a case where the signal type is a color verification preparation delay detection timer signal, the processing proceeds to S1532. In a case where the signal type is a color verification incomplete execution detection timer signal, the processing proceeds to S1571.

In S1521, the CPU 111 suspends all color verification preparation start timers. The schedule update signal is a signal sent by the CPU 132 in S1152. In S1522, the CPU 111 creates, updates, and deletes a schedule for starting all color verification preparation start timers, based on the color verification setting list. For example, in a case where there is a newly added schedule, a new color verification preparation start timer is added. In a case where there is an updated schedule, the setting of the color verification preparation start timer is changed. In a case where there is a schedule that is no longer necessary, the color verification preparation start timer is deleted. In S1523, the CPU 111 starts all color verification preparation start timers, and the processing returns to S1501. In a case where the processing of S1523 is executed, a color verification preparation start timer signal is activated as the color verification start time has arrived. At this time, hint information linking the timer and the color verification setting is assigned to the color verification preparation start timer.

In S1531, the CPU 111 executes color verification preparation start timer signal processing to be described later. In S1532, the CPU 111 executes color verification preparation delay detection timer signal processing to be described later. In S1571, the CPU 111 stops a color verification incomplete execution detection timer corresponding to the received timer signal. In S1572, the CPU 111 notifies an account, which is registered with the notification destination setting and has its notification condition attribute enabled upon color verification preparation delay/incomplete execution, of the color verification incomplete execution via the account management backend 257.

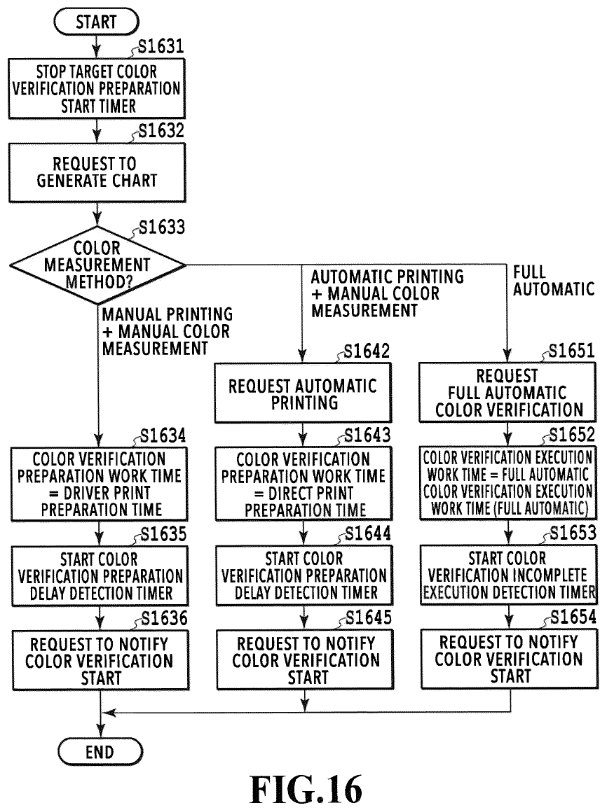

FIG. 16 is a flowchart of the color verification preparation start timer signal processing. In S1631, the CPU 111 stops the color verification preparation start timer corresponding to the received timer signal. In S1632, the CPU 111 requests the test chart generation module 256 to generate a chart. The test chart generation module 256 assigns a short code as identification information to identify each test chart. The short code generated in this processing is recorded in the scheduled-short-codes attribute of the color verification setting.

In S1633, the CPU 111 extracts the corresponding color verification setting based on the hint information assigned to the signal, and branches the processing based on the color measurement method in the color verification setting. In a case where the color measurement method is the “manual printing+manual color measurement” mode, the processing proceeds to S1634. In a case where the color measurement method is the “automatic printing+manual color measurement” mode, the processing proceeds to S1642. In a case where the color measurement method is the “full automatic” mode, the processing proceeds to S1651.

In S1634, the CPU 111 sets a driver print preparation time of the notification destination setting designated in the color verification setting as a color verification preparation work time. In S1635, the CPU 111 assigns the short code to the hint information and starts a color verification preparation work delay detection timer based on the color verification preparation work time. Specifically, the time at which the color verification preparation start timer signal is issued is the color verification start time. The color verification preparation delay detection timer is set so that the color verification preparation delay detection timer signal is issued at the time when the color verification preparation work time has elapsed since the time at which the color verification processing started. In S1636, the CPU 111 notifies the account for which the color verification start/completion notification condition 472 is enabled, among the notification destination accounts registered with the notification destination setting, of the start of color verification via the account management backend 257. In the color verification start notification, the test chart data itself may be notified, or a URL for downloading the test chart may be notified.

In S1642, the CPU 111 requests the device management backend 258 to automatically print the generated test chart. In S1643, the CPU 111 sets a direct print preparation time of the notification destination setting designated in the color verification setting as a color verification preparation work time. In S1644, the CPU 111 assigns a short code to the hint information and starts the color verification preparation work delay detection timer based on the color verification preparation work time. Specifically, the time at which the color verification preparation start timer signal is issued is the color verification start time. The color verification preparation delay detection timer is set so that the color verification preparation delay detection timer signal is issued at the time when the color verification preparation work time has elapsed since the time at which the color verification processing started. In S1645, the CPU 111 notifies the account for which the color verification start/completion notification condition attribute is enabled, among the accounts registered with the notification destination setting, of the start of color verification via the account management backend 257.

In S1651, the CPU 111 requests the device management backend 258 to perform full automatic color verification using the generated test chart. In S1652, the CPU 111 sets a full automatic color verification execution work time of the notification destination setting designated in the color verification setting as a color verification execution work time. In S1653, the CPU 111 assigns a short code to the hint information and starts a color verification incomplete execution detection timer based on the color verification execution work time. Specifically, the time at which the color verification incomplete execution detection timer signal is issued is the color verification start time. The color verification incomplete execution detection timer is set so that the color verification incomplete execution detection timer signal is issued at the time when the color verification execution work time has elapsed since the time at which the color verification process started. In S1654, the CPU 111 notifies the account for which the color verification start/completion notification condition attribute is enabled, among the accounts registered with the notification destination setting, of the start of color verification via the account management backend 257.

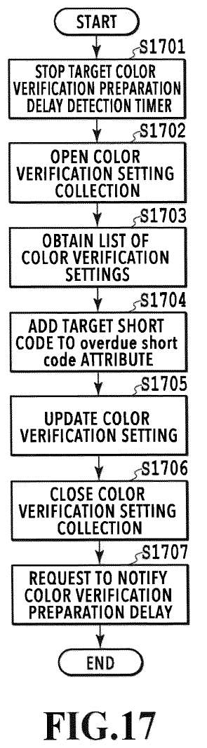

FIG. 17 is a flowchart of the color verification preparation delay detection timer signal processing. In S1701, the CPU 111 stops the color verification preparation delay detection timer corresponding to the received timer signal. In S1702, the CPU 111 opens a color verification setting collection. In S1703, the CPU 111 obtains a list of color verification settings from the color verification collection. In S1704, the CPU 111 adds a short code linked as hint information for the color verification preparation delay detection timer signal to the overdue-short-code attribute of the color verification setting. In S1705, the CPU 111 updates the color verification setting with the color verification setting having the overdue-short-code attribute updated. In S1706, the CPU 111 closes the color verification setting collection. In S1707, the CPU 111 notifies a color verification preparation delay to the account for which the notification condition attribute is enabled upon color verification preparation delay/incomplete execution, among the accounts registered with the notification destination setting, via the account management backend 257.

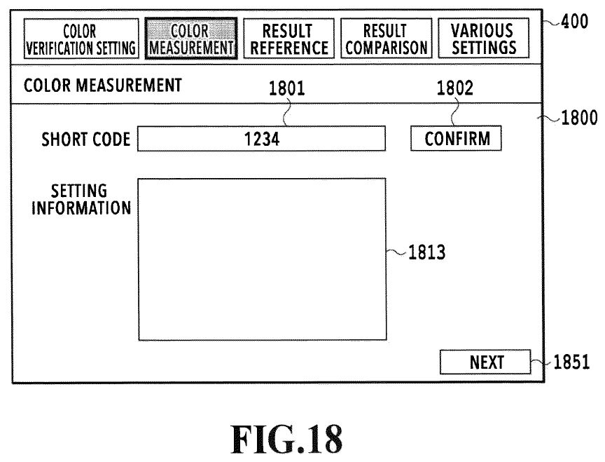

FIG. 18 is a diagram illustrating a setting screen of the color measurement application. The setting screen of the color measurement application includes the application switching bar 400 and a color measurement setting view 1800. The color measurement setting view 1800 includes a Short Code text box 1801, a “Confirm” button 1802, a setting information text box 1813, and a “Next” button 1851.

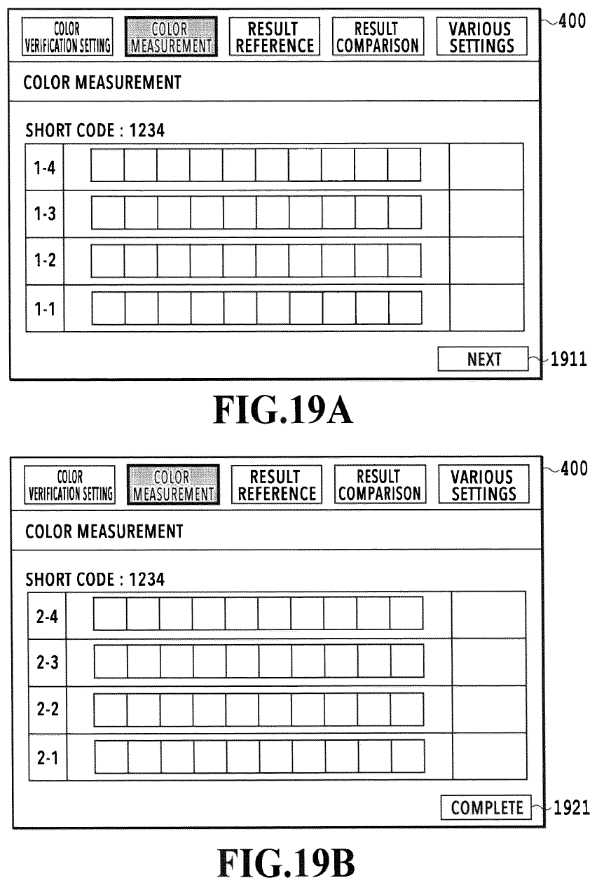

The Short Code text box 1801 is a text box for receiving a short code entered by the operator. The “Confirm” button 1802 is a button for confirming whether the short code entered by the operator is valid. The setting information text box 1813 is a text box for displaying various information related to the verified short code. The “Next” button 1851 becomes pressable as the short code entered in the Short Code text box 1801 is confirmed using the “Confirm” button 1802. Upon detection of the pressing of the “Next” button 1851, the CPU 132 transitions to color measurement screens illustrated in FIGS. 19A and 19B.

FIGS. 19A and 19B are diagrams illustrating the color measurement screens of the color measurement application. Note that a detailed explanation of color measurement would be very complicated. Therefore, since the present embodiment is characterized by the processing at the timing of starting and ending the color measurement, the timing of starting and ending the color measurement will be described.

FIG. 19A illustrates a first page of the color measurement screen. In the present embodiment, the color measurement preparation is considered to be completed as the color measurement screen is displayed. When the required color measurement is completed on the first page of the color measurement screen, a “Next” button 1911 becomes active. Then, upon detection of the pressing of the “Next” button 1911, the CPU 132 displays the next page.

FIG. 19B illustrates the last page of the color measurement screen. This page includes a “Complete” button 1921. The “Complete” button 1921 is a button for accepting that the color measurement has been completed. Upon detection of the pressing of the “Complete” button 1921, the CPU 132 executes the processing of the flowchart upon completion of color measurement to be described later.

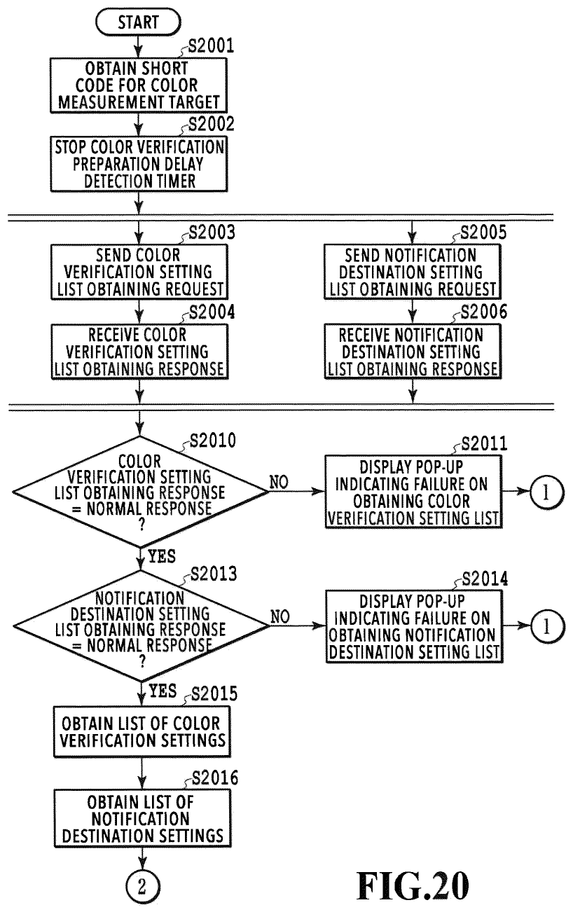

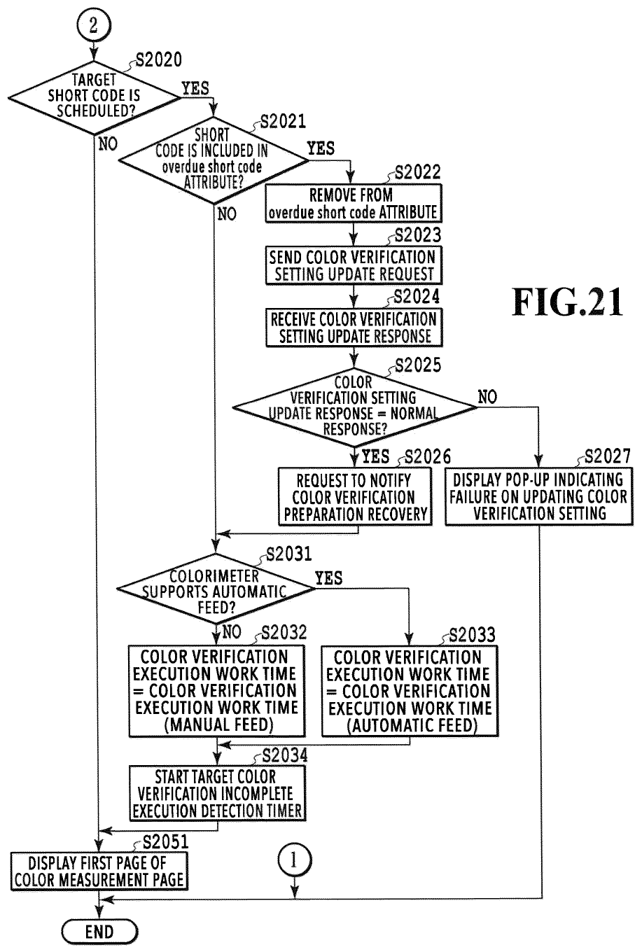

FIGS. 20 and 21 are flowcharts at the start of color measurement by the color measurement application. A program for executing the processing of these flowcharts is implemented in the color measurement application 292, and the CPU 132 executes the program. In S2001, the CPU 132 obtains the short code set on the setting screen from the hint information. In S2002, the CPU 132 stops the color verification preparation delay detection timer associated with the short code. Next, the CPU 132 executes the processing of S2003 and S2005 in parallel. In S2003, the CPU 132 sends a color verification setting list obtaining request to the color verification server 101. In S2004, the CPU 132 receives a color verification setting list obtaining response from the color verification server 101. In S2005, the CPU 132 sends a notification destination setting list obtaining request to the color verification server 101. In S2006, the CPU 132 receives a notification destination setting list obtaining response from the color verification server 101. The CPU 132 waits until the processing of both S2004 and S2006 is completed.

In S2010, the CPU 132 branches the processing based on the color verification setting list obtaining response. In a case where the color verification setting list obtaining response is a normal response, the processing proceeds to S2013. In a case where the color verification setting list obtaining response is an abnormal response, the processing proceeds to S2011. In S2011, the CPU 132 displays a pop-up indicating failure on obtaining the color verification setting list and ends the processing of this flowchart.

In S2013, the CPU 132 branches the processing based on the notification destination setting list obtaining response. In a case where the notification destination setting list obtaining response is a normal response, the processing proceeds to S2015. In a case where the notification destination setting list obtaining response is an abnormal response, the processing proceeds to S2014. In S2014, the CPU 132 displays a pop-up indicating failure on obtaining the notification destination setting list and ends the processing of this flowchart.

In S2015, the CPU 132 obtains a list of color verification settings from the color verification setting list obtaining response. In S2016, the CPU 132 obtains a list of notification destination settings from the notification destination setting list obtaining response. In S2020, the CPU 132 uses the obtained color verification setting list to branch the processing, depending on whether the obtained short code is registered with the scheduled-short-codes attribute of any of the color verification settings. In a case where the obtained short code is registered with the scheduled-short-codes attribute, the processing proceeds to S2021. In a case where the obtained short code is not registered with the scheduled-short-codes attribute, the processing proceeds to S2051.

In S2021, the CPU 132 determines whether the obtained short code is included in the overdue-short-code attribute of any of the color verification settings. In a case where the obtained short code is included in the overdue-short-code attribute of any of the color verification settings, the processing proceeds to S2022. In a case where the obtained short code is not included in the overdue-short-code attribute of any of the color verification settings, the processing proceeds to S2031.

In S2022, the CPU 132 removes the obtained short code from the overdue-short-code attribute of the color verification setting list. In S2023, the CPU 132 uses the updated color verification setting to send a color verification setting update request to the color verification server 101. In S2024, the CPU 132 receives a color verification setting update response from the color verification server. In S2025, the CPU 132 branches the processing based on the color verification setting update response. In a case where the color verification setting update response is a normal response, the processing proceeds to S2026. In a case where the color verification setting update response is an abnormal response, the processing proceeds to S2027. In S2026, the CPU 132 notifies color verification preparation recovery to the account for which the notification condition attribute is enabled upon color verification preparation delay/incomplete execution, among the accounts registered with the notification destination setting, via the account management backend 257. In S2027, the CPU 132 displays a pop-up indicating failure on updating the color verification setting, and ends the processing of this flowchart.

In S2031, the CPU 132 branches the processing based on whether the colorimeter designated in the color verification setting supports automatic feed. At this time, the CPU 132 specifies the color verification setting associated with the short code. Then, the CPU 132 calculates the color verification execution work time based on various settings in the notification destination setting designated in the color verification setting. In a case where the colorimeter supports automatic feed, the processing proceeds to S2033. In a case where the colorimeter does not support automatic feed, the processing proceeds to S2032. In S2032, the CPU 132 determines the color verification execution work time based on the color verification execution work time (manual feed) in the notification destination setting. In S2033, the CPU 132 determines the color verification execution work time based on the color verification execution work time (automatic feed) in the notification destination setting.

In S2034, the CPU 132 assigns a short code to the hint information and starts a color verification incomplete execution detection timer based on the color verification execution work time. Specifically, the color verification incomplete execution detection timer is set so that a color verification incomplete execution detection timer signal is issued at the time when the color verification execution work time has elapsed since the time at which the color verification processing started. In S2051, the CPU 132 displays the first page of the color measurement page and ends the processing of this flowchart.

Note that the present embodiment has been described by using, but not limited to, the configuration in which the processing of starting the color verification incomplete execution detection timer, which is the processing from S2031 to S2034, is executed on the color verification client 131 side. This processing may also be executed on the color verification server 101 side.

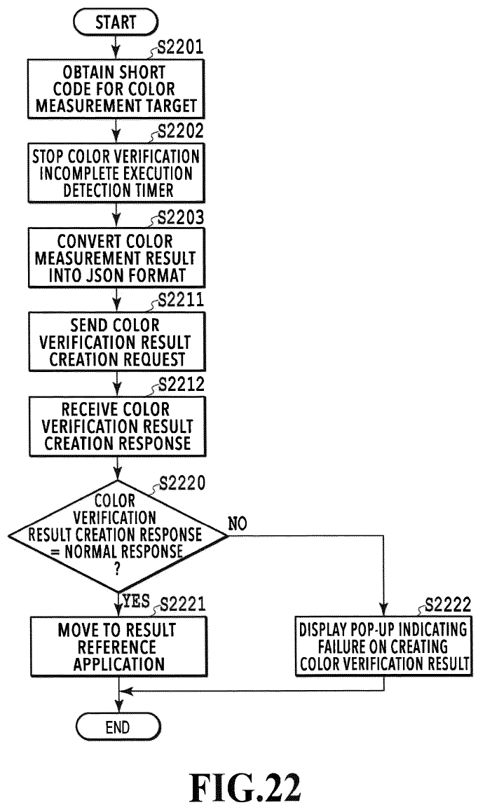

FIG. 22 is a flowchart of processing upon completion of the color measurement by the color measurement application. A program for executing the processing of this flowchart is implemented in the color measurement application 292, and the CPU 132 executes the program. In S2201, the CPU 132 obtains the short code set on the setting screen from the hint information. In S2202, the CPU 132 stops the color verification incomplete execution detection timer associated with the obtained short code. In S2203, the CPU 132 converts the color measurement result into the JSON format.

In S2211, the CPU 132 sends a color verification result creation request to the color verification server 101. In S2212, the CPU 132 receives a color verification result creation response from the color verification server 101. In S2220, the CPU 132 branches the processing based on the color verification result creation response. In a case where the color verification result creation response is a normal response, the processing proceeds to S222 l. In a case where the color verification result creation response is an abnormal response, the processing proceeds to S2222. In S2221, the CPU 132 switches the display to the result reference application. In S2222, the CPU 132 displays a pop-up indicating failure on creating the color verification result.

Now, a supplementary description is given of the features of the present disclosure, which have been clarified in the above-described embodiment. The present disclosure has the feature that a color verification task to be started from a designated scheduled color verification start time is managed by being divided into a color verification preparation phase and a color verification execution phase. Each phase has the necessity of consecutive execution. Then, the time required for the job in each phase is calculated and each phase is linked to the corresponding work time, thereby achieving smooth time management. The present disclosure also has a feature of notifying the inside and outside of the device in a case where the work time is exceeded. In other words, a work delay can be notified in a timely manner.

The present disclosure has the advantage of allowing flexible progress management by calculating and managing the work time on a phase-by-phase basis. In preparing for color measurement for color verification, the administrator or other operators can be quickly informed of the situation, such as a delay in work. The present disclosure also has a feature of linking the completion of the color verification preparation phase with the timing of starting the color verification execution phase. Dividing a task into independent subtasks as in the related art requires the administrator or operator to manually input a subtask of which completion cannot be detected. On the other hand, in the present disclosure, the task is divided into phases to be executed continuously in chronological order. The present disclosure has a feature that the completion of a preceding phase, of which completion cannot be detected by the system, is detected by the start of the subsequent phase. This eliminates the need for the operator to manually input the completion of the color verification preparation to the color verification system.

In addition, the work time of the color verification preparation phase is switched depending on the unit for printing the test chart for color verification. Accordingly, in a case of registering a schedule for color verification, the administrator can automatically set the time required for color verification preparation in conjunction with the unit for printing the test chart. In addition, the work time of the color verification execution phase can be switched depending on the unit for measuring the colors in the test chart. Furthermore, in a case of full automatic execution of color verification, it is possible to switch to a dedicated work time. This allows the administrator to automatically set the time required for the execution of color verification in conjunction with the unit for measuring the colors in the test chart, in a case of registering a schedule for color verification.

These features eliminate the need for the administrator to re-estimate the work time required for color verification for each schedule, leading to the advantage of making work more efficient. The present disclosure also has a feature of notifying a relevant administrator or operator of automatic recovery in a case where preparation for color verification is delayed and the color verification is executed. Accordingly, even if a plurality of administrators and operators are managing one printer, they can share the fact that recovery is started before all color verifications are completed.

### Second Embodiment

In the first embodiment, the description is given of the configuration in which the driver print preparation time, direct print preparation time, color verification execution work time (manual feed), color verification execution work time (automatic feed), and color verification execution work time (full automatic) are set to fixed values in the notification settings. In the present embodiment, description will be given of a configuration in which a recommended value is presented in a case of configuring notification settings for the various estimated times, and the notification settings are automatically configured upon color verification preparation or color verification execution.

The driver print preparation time in FIG. 4 is the estimated work time including the work time required for the operator to print a test chart using a printer device. The work time varies depending on the proficiency of the operator. Therefore, in S1634, the CPU 132 may sequentially save the time required for color verification preparation in the color verification result backend 255, and calculate a recommended value of an appropriate driver print preparation time based on the result. In the “automatic printing+manual color measurement” mode, the work time can be calculated as the difference between the color verification start time and the time at which color measurement is started by manual feed or automatic feed. In this case, not only a simple average value but also a median value or the like may be used. Such various modifications are possible without departing from the spirit of the present disclosure.

The direct print preparation time in FIG. 4 is the estimated work time including the work time required for the printer to automatically print a test chart at a designated time. The work time varies depending on the performance and attributes of the printer. For example, the CPU 132 can calculate an appropriate direct print preparation time according to the performance and attributes of a target engine for the printing via the device management service 104. For example, in a case of electrophotographic printing, it may take time to warm up, such as preheating a fixing unit. In a case of inkjet printing, it may take time to dry after printing. For the preferred implementation of the present disclosure, the direct print preparation time may be corrected in consideration of the attributes and performance of the device at the timing of starting direct printing in S1643.

The color verification execution work time (manual feed) in FIG. 4 is the estimated work time including the work time required for the operator to measure the colors in a test chart by manual feed using a colorimeter. For the preferred implementation of the present disclosure, in S2032, the CPU 132 may sequentially save the time required for color verification execution in the color verification result backend 255, and calculate a recommended value of an appropriate color verification execution work time (manual feed) based on the result.

The color verification execution work time (automatic feed) in FIG. 4 is the estimated work time including the work time required for the operator to measure the colors in a test chart by automatic feed using a colorimeter. For the preferred implementation of the present disclosure, in S2033, the CPU 132 may sequentially save the time required for color verification execution in the color verification result backend 255, and calculate a recommended value of an appropriate color verification execution work time (automatic feed) based on the result.

The color verification execution work time (full automatic) in FIG. 4 is the estimated work time including the work time required for the printer to automatically perform color adjustment, test chart printing, and color measurement with an inline sensor or inspection system at a designated time. The work time varies depending on the performance and attributes of the printer, and also the performance and attributes of the inline sensor or inspection system. For example, in a case where the printing speed of the printer is faster than the color measurement speed of the inline sensor, the estimated work time is determined by the color measurement speed of the inline sensor. On the other hand, in a case where the printing speed of the printer is slower than the color measurement speed of the inline sensor, the estimated work time is determined by the printing speed of the printer. For the preferred implementation of the present disclosure, the color verification execution work time (full automatic) may be corrected in consideration of the attributes and performance of the device at the timing of starting the color verification (full automatic) in S1652.

Under a condition that the above-mentioned work time (recommended value) does not match the current setting value in a case of displaying the notification destination setting screen of the various setting application 295 in FIG. 4, the above mentioned work time (recommended value) may be displayed as reference information in a pop-up or the like. In other words, the recommended values of the work time of the color verification preparation phase and the work time of the color verification execution phase may be displayed in a pop-up or the like before the execution of the color verification preparation phase.

Alternatively, in calculating the color verification preparation work time in S1634 and S1643, or calculating the color verification execution work time in S1653, S2032, and S2033, the above-mentioned work time may be dynamically replaced with the recommended work time. In other words, in executing the color verification preparation phase, the recommended value of the work time for the color verification preparation phase may be automatically set as the work time for the color verification preparation phase. Also, in executing the color verification execution phase, the recommended value of the work time for the color verification execution phase may be automatically set as the work time for the color verification execution phase.

As described above, the color verification preparation work time and the color verification execution work time in the present disclosure are not only the fixed values preset by the administrator, but the color verification system can present the recommended work times and automatically set the color verification preparation work time and the color verification execution work time.

### Third Embodiment

In the first embodiment, the description is given of the configuration in which the color verification preparation delay and color verification execution completion of the color verification task are notified to the notification destination account by email. In the present disclosure, notification method other than email can also be used to notify the operator.

In a case where the CPU 111 requests the account management service 103 to notify the color verification preparation delay or color verification incomplete execution in S1707 or S1572, the same notification may be sent to the device management service 104 at the same time. The device management service 104 requests the controller 151 and the controller 160 to display various warnings. These modifications will be described in detail.

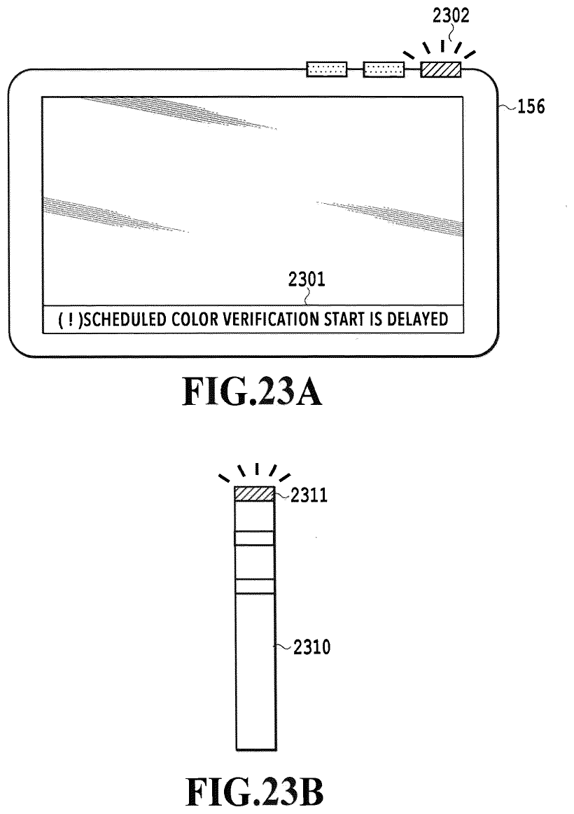

FIG. 23A is a diagram illustrating a display example of various warnings on the device side UI. For example, upon receipt of a warning display request, the controller 151 requests the printer 150 to light or blink a warning display LED 2302 provided in the device UI 156. This allows the operator who can see the warning display LED 2302 of the printer 150 to notice that the printer 150 is issuing some kind of warning. The controller 151 also requests the printer 150 to display a warning message 2301 on the device UI 156. This allows the operator to grasp the details of the warning issued by the printer 150 via the device UI 156.

FIG. 23B is a display example of various warnings using a warning light on the device side. Depending on the installation location, the operator cannot necessarily see the device UI 156 from a distance. Therefore, the device UI 156 may be further installed with a warning light 2310 that can be seen from a distance. The operator or the like may be notified that a warning has been issued by lighting or blinking a warning display LED 2311.

An example of displaying various warnings on the printer-side UI has been described above. However, in the present disclosure, various warnings may be displayed on the controller-side UL. For example, a warning display request to the controller 160 may be displayed on the controller UI 161. These various modifications are applicable without departing from the spirit of the present disclosure.

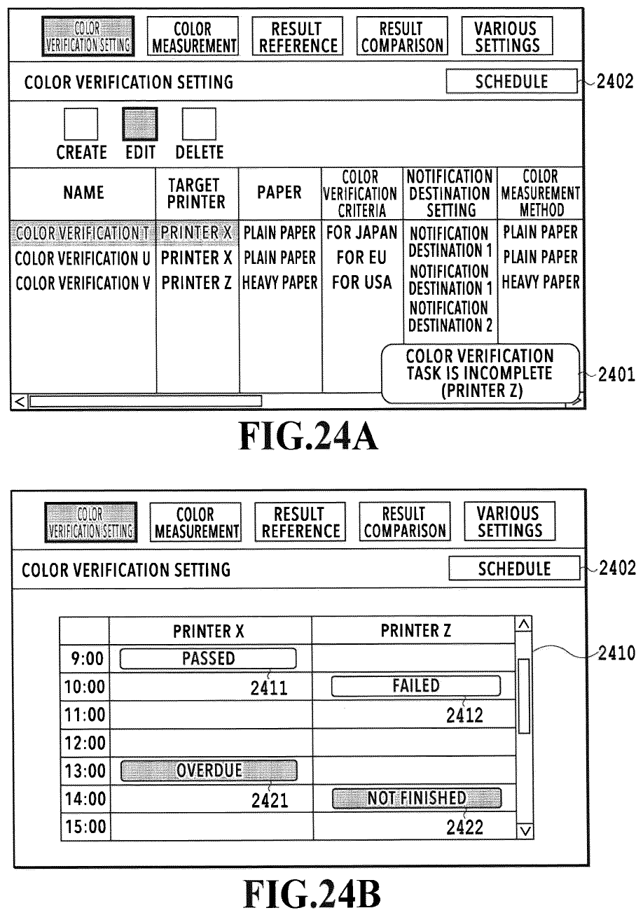

FIG. 24A is a diagram illustrating an example of a color verification incompletion warning superimposed and displayed on the color verification setting application screen. In a case where the CPU 111 requests the account management service 103 to notify a color verification preparation delay or color verification incomplete execution in S1707 or S1572, the same notification may be sent to the color verification client program 290 at the same time. The CPU 132 superimposes and displays the warning as a pop-up dialog box on screens displayed by various applications.

By superimposing and displaying a warning pop-up 2401 on a normal color verification setting screen, the operator or the like can confirm the warning even in a case of performing other work. Here, a schedule button 2402 is a button for switching the color verification setting screen to a schedule mode to be described later.

FIG. 24B is a diagram illustrating a display example of the schedule mode. The color verification setting application 291 may have the schedule mode to check the scheduled color verification start time and the like of the color verification task from a bird's-eye view. In the schedule mode, the start time and the status of a color verification task are expressed for each time. A color verification task 2411 is a color verification task whose color verification result is Passed. A color verification task 2412 is a color verification task whose color verification result is Failed. A color verification task 2421 is a color verification task whose color verification preparation is delayed. A color verification task 2422 is a color verification task whose color verification execution is incomplete. In the present disclosure, the color verification task is expressed differently in the color verification preparation delay state and the color verification incomplete execution state. This allows the operator to clearly determine what to do with the color verification task upon checking the schedule mode.

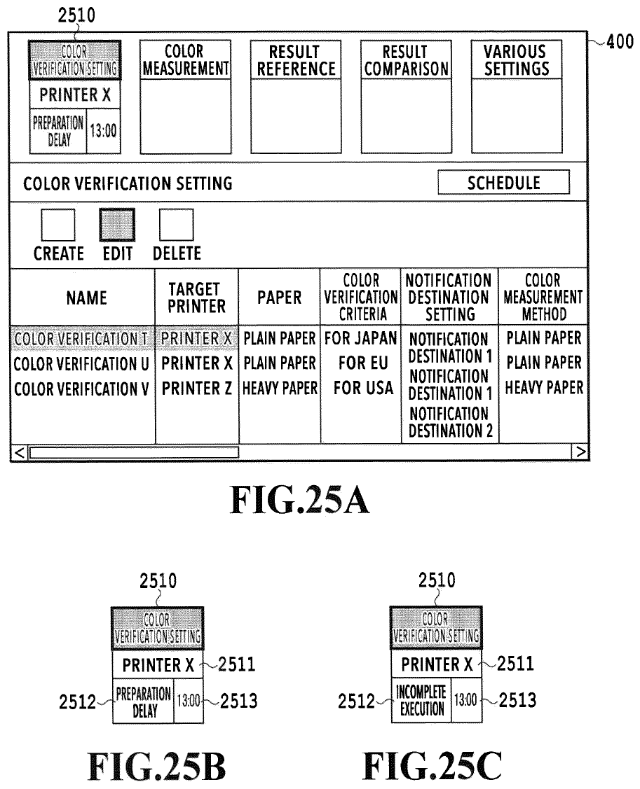

FIG. 25A is a diagram illustrating an example of displaying a color verification task status on an application switching button. The status of a certain color verification task may be displayed on a color verification setting button 2510 on the application switching bar 400. For example, a color verification task closest to the displayed current time may be the display target.

FIG. 25B illustrates a display example of the color verification setting button 2510 upon color verification preparation delay. The color verification setting button 2510 includes a target printer 2511, a color verification phase status 2512, and color verification phase time information 2513. The target printer 2511 displays the name of a target printer for the color verification. The color verification phase status 2512 displays the status of the color verification phase. The color verification phase time information 2513 displays the time of a change to the status of the color verification. FIG. 25C illustrates a display example of the color verification setting button 2510 upon color verification incomplete execution. Since FIG. 25C illustrates almost the same contents as FIG. 25B, details will be omitted. In this way, the progress or the like of each phase can be displayed in the area displaying supplementary information about the application while the application is running.

As described above, in a case of displaying the color verification task status on the application switching button, it is possible to clearly distinguish whether the status of the color verification task is the color verification preparation delay or the color verification incomplete execution.

In addition to the above, the color verification preparation delay notification and the color verification incomplete execution notification of the present disclosure may be notified to an external tool. The Web Server 250 of the first embodiment is based on Web API communication. Other protocols may be supported. The Web Server 250 may support, for example, SNMP (Simple Network Management Protocol) or IPP (Internet Printing Protocol). Alternatively, the Web Server 250 may support JAMF (Job Messaging Format). The Web Server 250 may also support a REST API (Representational State Transfer API). Modifications of these formats can be extended without departing from the spirit of the present disclosure.

By utilizing these protocol extensions, for example, a color verification preparation delay notification or a color verification incomplete execution notification can be displayed on a mobile application running on the mobile phone 123 used by the operator. The method for displaying the notified information can be modified without departing from the spirit of the present disclosure.

In addition, for example, in a case of manual printing in which print data of a test chart executed in the period 302 of FIG. 3 is obtained and printed using a printer driver, the color verification system sometimes does not detect a completion event of the manual printing. In such a case, upon detection of an event in which manual color measurement or automatic color measurement, which is a subsequent phase, is started, the color verification system determines that a completion event of the preceding phase is detected. That is, in a case where there is no event indicating that the preceding phase is completed, and the color verification system detects an event indicating that the subsequent phase is started, the color verification system considers that the preceding phase is completed. In other words, the start event of the subsequent phase also serves as the completion event of the preceding phase.

The technology of the present disclosure makes it possible to notify a work delay in a timely manner.

### Other Embodiments

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173167, filed Oct. 2, 2024, which is hereby incorporated by reference herein in its entirety.

What is claimed is:

1. A color verification system for managing a color verification task, comprising:
at least one memory and at least one processor which function as:
a management unit configured to manage the color verification task by dividing the task into two or more phases including a first phase and a second phase;
a linking unit configured to link the first phase to a first work time and the second phase to a second work time; and
a notification unit configured to notify a user that work of the first phase is incomplete, in a case where a work completion event for the first phase is not detected and the first work time has elapsed.

2. The color verification system according to claim 1, wherein the two or more phases are executed consecutively.

3. The color verification system according to claim 1, wherein
the first phase is a color verification preparation phase,
the second phase is a color verification execution phase, and
the first phase is executed prior to the second phase.

4. The color verification system according to claim 3, wherein,
in a case where there is no work completion event for the first phase, a start event for the second phase is used as the work completion event for the first phase.

5. The color verification system according to claim 3, wherein
the management unit performs processing of
determining a work time of the color verification preparation phase, in a case where a print unit manually prints a test chart used in color verification, based on a time required for manual test chart printing, and
determining the work time of the color verification preparation phase, in a case where the print unit automatically prints the test chart used in color verification, based on a time required for automatic test chart printing.

6. The color verification system according to claim 3, wherein
the management unit performs processing of
determining a work time of the color verification execution phase, in a case where a color measurement unit configured to perform color measurement of a test chart used in color verification does not support automatic feed, based on a time required for color measurement of the test chart by manual feed, and
determining the work time of the color verification execution phase, in a case where the color measurement unit supports automatic feed, based on a time required for color measurement of the test chart by automatic feed.

7. The color verification system according to claim 3, wherein
the management unit presents to the notification unit recommended values of a work time of the color verification preparation phase and a work time of the color verification execution phase before the color verification preparation phase is executed.

8. The color verification system according to claim 3, wherein
the management unit automatically sets a recommended value of a work time of the color verification preparation phase to the work time of the color verification preparation phase in a case of execution of the color verification preparation phase, and automatically sets a recommended value of a work time of the color verification execution phase to a work time of the color verification execution phase in a case of execution of the color verification execution phase.

9. The color verification system according to claim 3, wherein,
in a case where the first phase and the second phase are both executed automatically, the management unit determines a work time of the color verification execution phase based on a time required for automatic color verification, without dividing the color verification task into the first phase and the second phase.

10. The color verification system according to claim 1, wherein
the notification unit notifies a registered notification destination of a delay in the first phase or the second phase by email.

11. The color verification system according to claim 1, wherein
the notification unit temporarily displays a delay in the first phase or the second phase by a pop-up on a display device while an application is running.

12. The color verification system according to claim 1, wherein
the notification unit displays a delay in the first phase or the second phase in an area displaying supplementary information on an application while the application is running.

13. The color verification system according to claim 5, wherein
the notification unit displays a user interface screen to notify a delay in the first phase or the second phase via a user interface installed in the print unit or a user interface installed in a controller connected to the print unit.

14. The color verification system according to claim 5, wherein
the notification unit notifies a delay in the first phase or the second phase by lighting or blinking an LED or a warning light installed in the print unit.

15. A method of controlling a color verification system for managing a color verification task, comprising:
managing the color verification task by dividing the task into two or more phases including a first phase and a second phase;
linking the first phase to a first work time and the second phase to a second work time; and
notifying a user that work of the first phase is incomplete, in a case where a work completion event for the first phase is not detected and the first work time has elapsed.

16. A color verification server which manages a color verification task, comprising:
at least one memory and at least one processor which functions as:
a management unit configured to manage the color verification task by dividing the task into two or more phases including a first phase and a second phase;
a linking unit configured to link the first phase to a first work time and the second phase to a second work time; and
a notification unit configured to notify a user that work of the first phase is incomplete, in a case where a work completion event for the first phase is not detected and the first work time has elapsed.

17. A non-transitory computer readable storage medium storing a program which causes a computer to execute a method of controlling a color verification server which manages a color verification task, the method comprising:
managing the color verification task by dividing the task into two or more phases including a first phase and a second phase;
linking the first phase to a first work time and the second phase to a second work time; and
notifying a user that work of the first phase is incomplete, in a case where a work completion event for the first phase is not detected and the first work time has elapsed.
